(19) United States
(12) Patent Application Publication
(10) Pub. No.: US 2013/0275134 A1
(43) Pub. Date: Oct. 17, 2013

(54) INFORMATION EQUIPMENT

(71) Applicants: Akio Horii, Tokyo (JP); Tomohiro Narita, Tokyo (JP)

(72) Inventors: Akio Horii, Tokyo (JP); Tomohiro Narita, Tokyo (JP)

(73) Assignee: MITSUBISHI ELECTRIC CORPORATION, Tokyo (JP)

(21) Appl. No.: 13/991,916

(22) PCT Filed: Feb. 6, 2012
(86) PCT No.: PCT/JP2012/052627

§ 371 Date: Jun. 6, 2013

(30) Foreign Application Priority Data
May 20, 2011 (JP) 2011-113294

(51) Int. Cl. G10L 15/26

(52) U.S. Cl. CPC G10L 15/26
USPC 704/235

(57) ABSTRACT

An information equipment for displaying shortcut keys for operating the information equipment on a screen and rearranging the displayed shortcut keys on the screen based on a recognition result of an input voice, the information equipment including: a voice recognition processor referring to a recognition dictionary database memory to output text as a recognition result of an input voice; and a shortcut key rearranging mechanism referring to a conversion database memory, where an association relation between a function of the information equipment and text is written, mapping the recognition result text onto a function of the information equipment, and displaying a shortcut key to the function on the display screen.

### TECHNICAL FIELD

The present invention relates to an information equipment for rearranging shortcut keys displayed on a screen and used to operate functions of the information equipment based on a user's input voice.

### BACKGROUND ART

A multi-modal information equipment having a touch-screen operation feature and a voice-activated operation feature, such as a car navigation system, has been developed. In touch-screen operation, a screen transition relation may be built on the hierarchical structure of a specific function of the equipment and, in that case, the user gets closer and closer to a desired function to execute the function with the progress of touch-screen operation. However, this requires one touch-screen operation step for one screen transition, which means that many operation steps are necessary to execute some functions, and is therefore inconvenient.

Voice-activated operation, on the other hand, allows the user to execute a desired function by uttering a command only once irrespective of what the command is, and can thus compensate for the inconvenience of touch-screen operation. However, a function that is not the one desired by the user is sometimes executed due to misspeaking or false recognition.

Voice recognition devices used in this type of information equipment are devices for mapping/executing a function, or for displaying a candidate function list when there are a plurality of candidate functions, based on words that are obtained by voice recognition processing. Voice recognition devices are used in the field of voice recognition and are effective for a device that is operated with various words.

Conventional voice recognition devices select a function based on a word that is acoustically and linguistically the most probable match to the user's utterance recognized by voice recognition (for example, Patent Literature 1).

Based on the word that is the most probable match, the most probable function is further selected with the use of a conversion data base, which associates a function with related phrase information, and the following Expression (1) (for example, Patent Literature 2).

$$\begin{matrix}[ Math . 1 ] & \\ \begin{matrix}\hat{C} = {argmax}_{C} P ( C \vert X ) \\ = {argmax}_{C} P ( C ) P ( X \vert C ) / P ( X ) \\ = {argmax}_{C} P ( C ) P ( X \vert C )\end{matrix} & ( 1 )\end{matrix}$$

In Expression (1), C represents a function, X represents an input voice, P(C) represents the occurrence probability of each function which is known beforehand, P(X|C) represents the likelihood of the input voice based on a probability model learned in advance, and argmax is given as a function that returns an element having the maximum value out of all elements.

### CITATION LIST

### Patent Literature [PTL 1]: JP 09-50291 A [PTL 2]: WO 2007/114226 A1

### SUMMARY OF INVENTION

### Technical Problem

A voice recognition device used in an information equipment that has a touch-screen operation feature and a voice-activated operation feature selects functions based on Expression (1) and then executes a function that has the highest occurrence likelihood P(X|C), or presents a plurality of candidate functions having higher occurrence likelihood values to the user to choose from. Executing or presenting functions that are selected based on a false recognition result in the first place can confuse the user because functions that are completely different from what the user has uttered is executed or presented. In addition, returning to a state prior to the utterance takes a lot of trouble once a falsely recognized command is executed/presented. This is particularly true when the functions are complicated.

Moreover, there is a problem in that the design of the voice recognition device does not take into consideration making a manual correction in the event of misspeaking. Accordingly, if the user misspeaks, the voice recognition device inevitably executes a function or presents a plurality of candidate functions, thus necessitating processing of cancelling the executed function or similar processing in preparation for the next utterance. Returning to a state prior to the utterance is therefore laborious. Another problem is that learning functions cannot be performed, or at least is difficult, without reading a manual that is attached to the voice recognition device.

The present invention has been made to solve the problems described above, and an object of the present invention is to prevent a user's confusion by rearranging shortcut keys to functions so that the user can make the final decision via more definite operation such as touch-screen operation, and explicitly showing which function is executed in response to the user's utterance. Another object of the present invention is to avoid a correction work via touch-screen operation that is required to receive the next utterance in the event of misspeaking. Still another object of the present invention is to provide a high effect for learning a voice-activated operation method by enabling the user to test voice-activated operation many times in a short period of time without interruptions of the trial voice-activated operation from forced execution of a system function.

### Solution to Problem

According to the present invention, there is provided an information equipment for displaying shortcut keys for operating the information equipment on a screen and rearranging the displayed shortcut keys on the screen based on a voice recognition result of an input voice, the information equipment including: voice recognition processing means for inputting a voice and referring to a recognition dictionary database memory to output text as a recognition result; and shortcut key rearranging means for inputting the text as the recognition result of the voice recognition processing means, referring to a conversion database memory, where an association relation between a function of the information equipment and text as the recognition result is written, mapping the recognition result text onto a function of the information equipment, and displaying a shortcut key to the function on the display screen.

### Advantageous Effects of Invention

The shortcut key rearranging means can display, on the display screen, shortcut keys to functions of the information equipment by mapping text that is a voice input recognized by the voice recognition processing means and the functions of the information equipment with reference to the conversion database memory. The resultant effect is that a function can be executed without a transition to a deeper hierarchy level via button operation.

Another effect is that executing a function that is not intended by the user due to false recognition or the like is prevented because a function is executed when the user ultimately presses one of the shortcut keys displayed on the display screen, as opposed to the case where a function is executed by voice-activated operation.

### BRIEF DESCRIPTION OF DRAWINGS

FIG. 1 A diagram of an operation screen illustrating an example of function relations in a multi-modal information equipment.

FIG. 2 A configuration diagram illustrating an information equipment according to a first embodiment of the present invention.

FIG. 3 A configuration diagram of shortcut key rearranging means according to the first embodiment.

FIG. 4 Explanatory diagrams of how a display screen looks before and after shortcut key rearrangement according to the first embodiment.

FIG. 5 A flow chart illustrating the operation of the information equipment of the first embodiment.

FIG. 6 An explanatory diagram of the contents of a conversion database memory 5 of the first embodiment.

FIG. 7 An explanatory diagram of a key conversion database 7 of the first embodiment.

FIG. 8 A configuration diagram illustrating shortcut key rearranging means according to a second embodiment of the present invention.

FIG. 9 A flow chart illustrating the operation of an information equipment according to the second embodiment.

FIG. 10 An explanatory diagram of an operation history database memory of the second embodiment.

FIG. 11 An explanatory diagram of an erasure time limit database memory of the second embodiment.

FIG. 12 A configuration diagram illustrating shortcut key rearranging means according to a third embodiment of the present invention.

FIG. 13 A flow chart illustrating the operation of an information equipment according to the third embodiment.

FIG. 14 An explanatory diagram of a display history database memory in the third embodiment.

FIG. 15 A configuration diagram illustrating shortcut key rearranging means according to a fourth embodiment of the present invention.

FIG. 16 A flow chart illustrating the operation of an information equipment according to the fourth embodiment.

FIG. 17 An explanatory diagram of an operation history database of the fourth embodiment.

FIG. 18 A configuration diagram illustrating shortcut key rearranging means according to a fifth embodiment of the present invention.

FIG. 19 A flow chart illustrating the operation of an information equipment according to the fifth embodiment.

FIG. 20 An explanatory diagram of a recognition history database memory of the fifth embodiment.

FIG. 21 A configuration diagram illustrating shortcut key rearranging means according to a sixth embodiment of the present invention.

FIG. 22 A flow chart illustrating the operation of a voice recognition device according to the sixth embodiment.

FIG. 23 An explanatory diagram illustrating an example of a current state database memory in the sixth embodiment.

FIG. 24 A configuration diagram illustrating shortcut key rearranging means according to a seventh embodiment of the present invention.

FIG. 25 A flow chart illustrating the operation of an information equipment according to the seventh embodiment.

FIG. 26 An explanatory diagram of the contents of an operation recognition history database memory in the seventh embodiment.

FIG. 27 A configuration diagram illustrating shortcut key rearranging means according to an eighth embodiment of the present invention.

FIG. 28 A flow chart illustrating the operation of an information equipment according to the eighth embodiment.

FIG. 29 An explanatory diagram of an example of the contents of a display order database memory in the eighth embodiment.

FIG. 30 Explanatory diagrams of how a display screen looks before and after shortcut key rearrangement and after the display order is changed according to the eighth embodiment.

FIG. 31 A configuration diagram illustrating shortcut key rearranging means according to a ninth embodiment of the present invention.

FIG. 32 A flow chart illustrating the operation of an information equipment according to the ninth embodiment.

FIG. 33 An explanatory diagram of an example of the contents of a display method database memory in the ninth embodiment.

FIG. 34 Explanatory diagrams of how a display screen looks before and after shortcut key rearrangement and after a change in display method according to the ninth embodiment.

FIG. 35 A configuration diagram illustrating shortcut key rearranging means according to a tenth embodiment of the present invention.

FIG. 36 A flow chart illustrating the operation of an information equipment according to the tenth embodiment.

FIG. 37 Explanatory diagrams of how a display screen looks before and after shortcut key rearrangement and after a change in display order and display method according to the tenth embodiment.

FIG. 38 A configuration diagram illustrating shortcut key rearranging means according to an eleventh embodiment of the present invention.

FIG. 39 A flow chart illustrating the operation of an information equipment according to the eleventh embodiment.

FIG. 40 An explanatory diagram of an example of the contents of a displayed key data database memory in the eleventh embodiment.

FIG. 41 Explanatory diagrams of how a display screen looks before and after shortcut key rearrangement and after a change in display method according to the eleventh embodiment.

FIG. 42 A configuration diagram illustrating shortcut key rearranging means according to a twelfth embodiment of the present invention.

FIG. 43 A flow chart illustrating the operation of an information equipment according to the twelfth embodiment.

FIG. 44 An explanatory diagram of an example of the contents of a displayed key relevant information database memory in the twelfth embodiment.

FIG. 45 A configuration diagram illustrating shortcut key rearranging means according to a thirteenth embodiment of the present invention.

FIG. 46 A flow chart illustrating the operation of an information equipment according to the thirteenth embodiment.

FIG. 47 An explanatory diagram of an example of the contents of a hierarchy function database memory in the thirteenth embodiment.

### DESCRIPTION OF EMBODIMENTS

The present invention has a feature in that shortcut keys are rearranged in order to avoid a correction work in the event of false recognition or misspeaking beforehand.

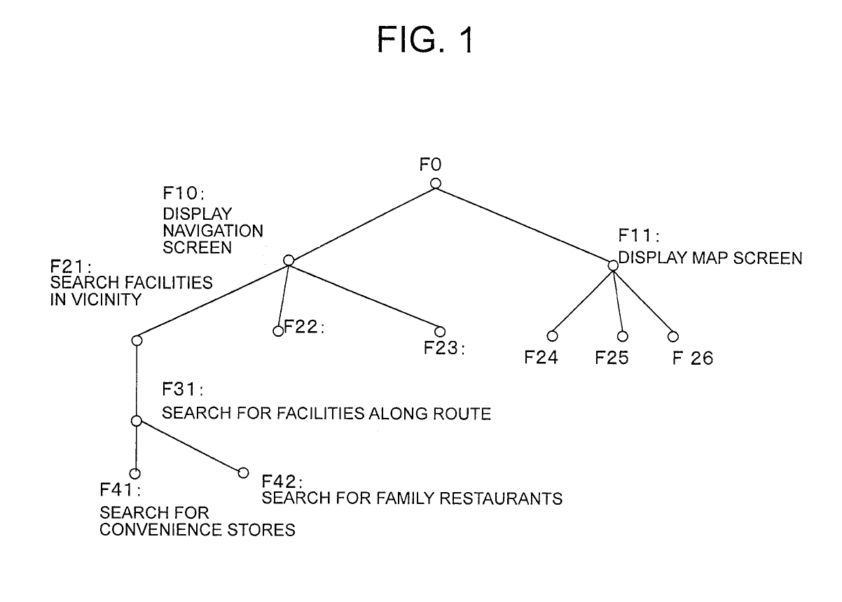

FIG. 1 is a diagram of an operation screen illustrating an example of function relations in an information equipment. The procedure of executing a function based on touch-screen operation involves first presenting an operation screen, shifting from one screen to another by repeating the operation of selecting an item in the screen on the user's part, and finally executing a desired command. Intermediate nodes having lower nodes each represent a selection screen showing a function classification, and the lowermost nodes each represent a specific function. The user operates the screen to track from an initial node F0 via intermediate nodes F10, F11, F21, and F31 down to one of the lowermost nodes F22 to F26, F41, and F42, and thereby execute a specific function associated with the lowermost node.

In voice-activated operation, on the other hand, the user can take a shortcut to a distal function from the initial node F0 and execute the function by directly speaking words that correspond to the function.

### First Embodiment

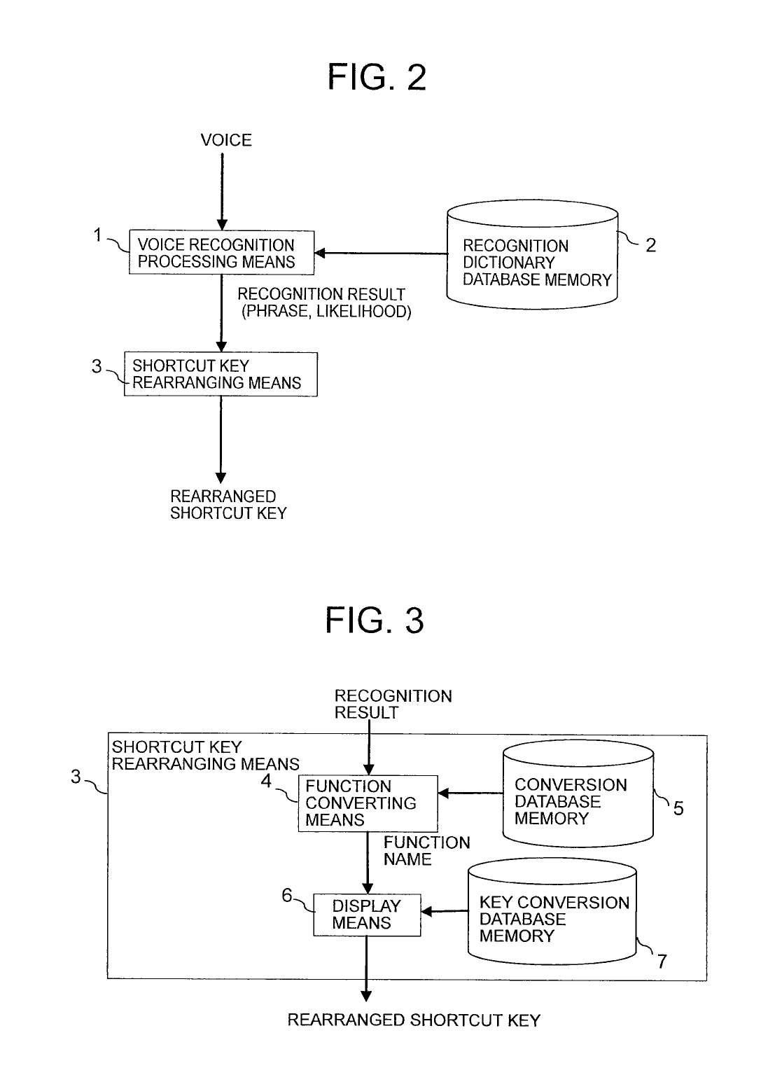

FIG. 2 is a configuration diagram illustrating main components of an invention of an information equipment according to a first embodiment of the present invention.

In FIG. 2, the information equipment in the present invention includes voice recognition processing means 1, a recognition dictionary database memory 2, and shortcut key rearranging means 3.

The voice recognition processing means 1 is means for receiving a voice uttered by the user as an input, performing A/D conversion to convert the input voice into voice data, referring to the recognition dictionary database memory 2 to recognize words in the voice data, and outputting text and an occurrence likelihood as a recognition result. As the recognition result, the voice recognition processing means 1 outputs a candidate list in which the most probable word is the first candidate and predicted words are sorted in the order of likelihood as the second to, for example, fifth candidates in a manner described in, for example, Japanese Patent Application Laid-open No. Sho 60-166997.

The recognition dictionary database memory 2 is a memory for storing a database of an acoustic model and a language model that are used to recognize words and calculate the occurrence likelihood of a recognition result in the voice recognition processing means 1.

The shortcut key rearranging means 3 includes, as illustrated in FIG. 3, function converting means 4, a conversion database memory 5, display means 6, and a key conversion database memory 7. The function converting means 4 is means for receiving the recognition result output from the voice recognition processing means 1 as an input, referring to the conversion database memory 5, calculating a function occurrence likelihood for each function of the information equipment that is written in the conversion database memory 5, and outputting the name of the most probable function out of the functions of those functions. The display means 6 is means for receiving the function name from the function converting means 4 as an input, referring to the key conversion database memory 7, and outputting a rearranged shortcut key that is a shortcut key associated with the input function name. The shortcut key rearranging means 3 outputs, as rearranged shortcut keys, shortcut keys to predicted functions with a shortcut key to the most probable function as the first candidate.

The conversion database memory 5 is a memory for storing a database in which the association between a function name and a related phrase is written in order to determine a function name from a voice recognition result. In other words, the conversion database memory 5 is built to have a table structure that stores, as conversion information, a plurality of function name-related words in association with a function name.

The key conversion database memory 7 is a memory for storing a database in which the association between a function name and a shortcut key is written in order to determine a rearrangement target shortcut key from a function name. In other words, the key conversion database memory 7 is built to have a table structure that stores a rearrangement target shortcut key as conversion information with respect to a function name.

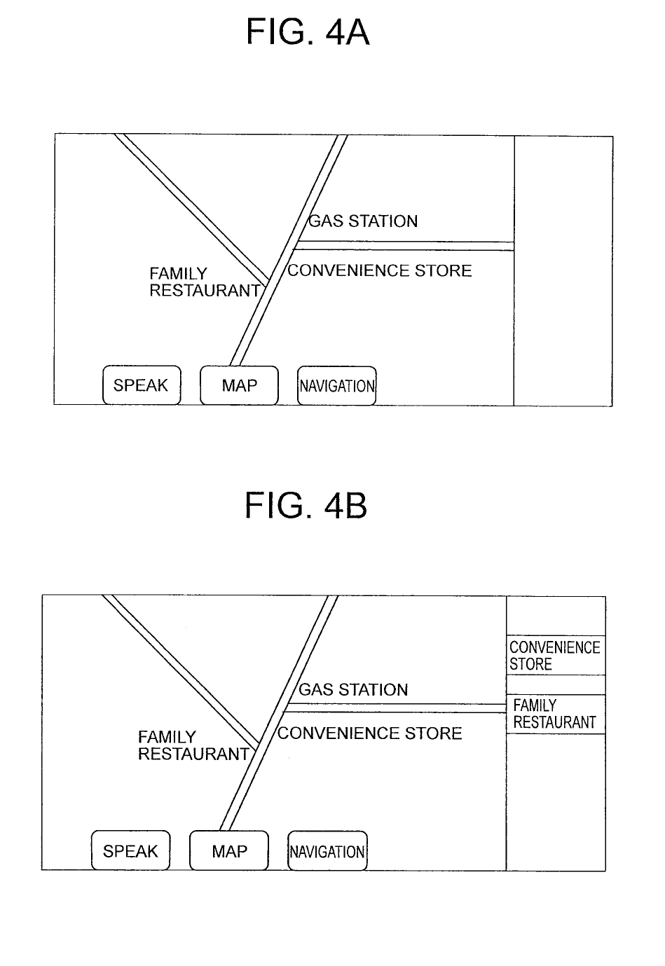

The rearranged shortcut keys that are output are presented as illustrated in FIG. 4(B), for example. The screen in FIG. 4(B) displays, from the top of the right side of the display screen downward, a [convenience store] icon which corresponds to “search for convenience stores” and a [family restaurant] icon which corresponds to “search for family restaurants” in the upper right part as icons indicating the specifics of functions. However, the icons can be displayed in any part of the display screen. Information displayed as an icon can be in any graphic form that the user can understand instinctively. The icons can be displayed at other times than immediately after the rearrangement, and may be at display timing desired by the user, for example, immediately after a specific operation such as pressing a button assigned for the displaying of the icons. The user presses the icon of one of functions displayed on the display screen to cause the information equipment to execute the function.

In the description given above, a phrase between quotation marks is a function name and a bracketed word is displayed letters of a shortcut key.

FIG. 4(A) illustrates, for reference, the display screen prior to the shortcut key rearrangement.

How the information equipment operates is described next.

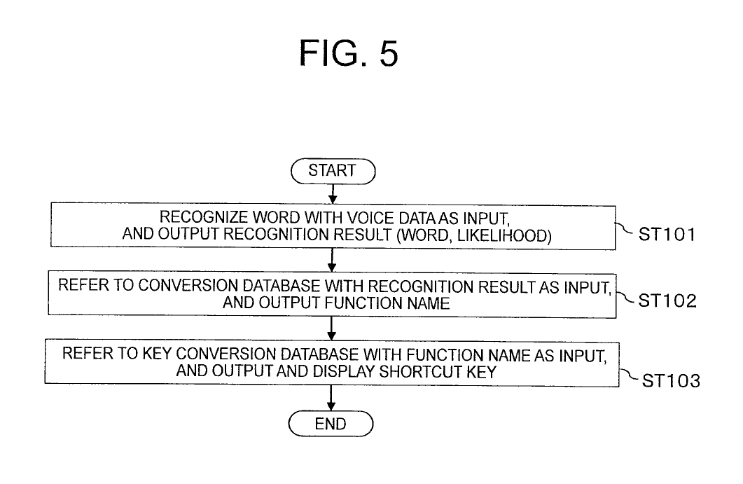

FIG. 5 is a flow chart illustrating the operation of the information equipment of the first embodiment.

The voice recognition processing means 1 is generally set up in the vicinity of the user who is the speaker or held by the user so that the user's voice is input to the voice recognition processing means 1. The voice recognition processing means 1 has built-in voice inputting means which performs 16-bit A/D conversion on the input voice at a sampling rate of 16 kHz, for example, and outputs voice data (Step ST101).

The voice recognition processing means 1 further uses the voice data that is the output of the built-in voice inputting means as an input for determining voice activity by a known method, refers to a relevant acoustic model and a relevant language model in the recognition dictionary database memory 2 for matching with voice data of the determined audio activity, and outputs the most probable phrase as a recognition result (Step ST102).

The voice recognition result which is the output of the voice recognition processing means 1 is input to the shortcut key rearranging means 3, and the shortcut key rearranging means 3 outputs rearranged shortcut keys and likelihood (Step ST103).

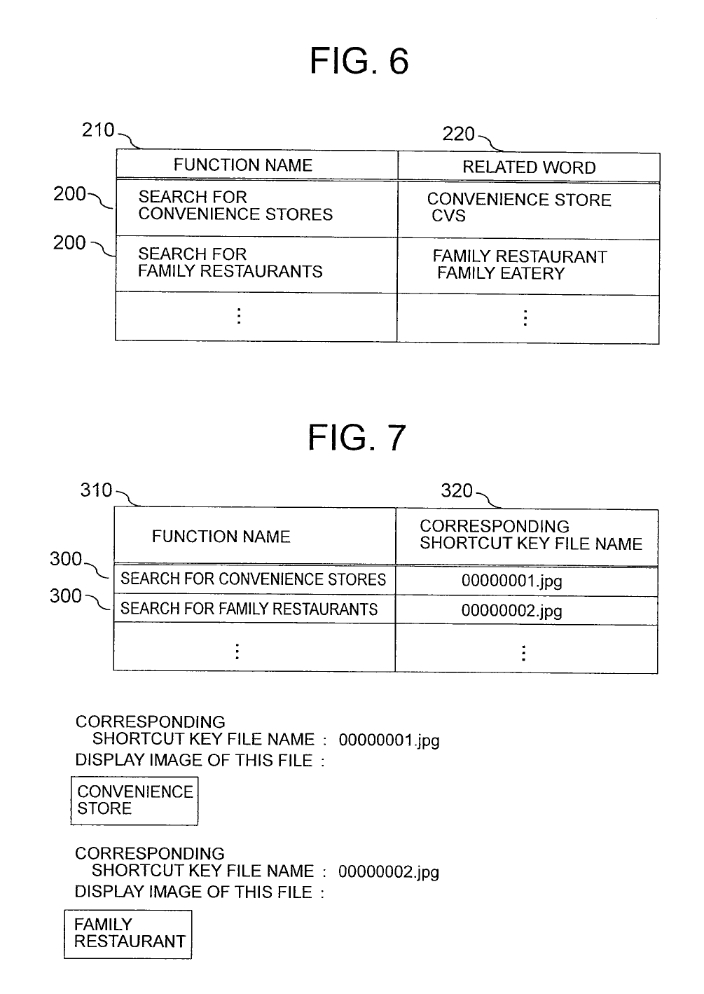

FIG. 6 is an explanatory diagram of the contents of the conversion database memory 5 used to calculate likelihood as an index for determining a function name to be output by the function converting means 4 which is internal processing of the shortcut key rearranging means 3 of the first embodiment. The operation of the shortcut key rearranging means 3 is described in detail below with reference to FIG. 6.

In FIG. 6, when the user's utterance input to the voice recognition processing means 1 is “convenience store”, for example, likelihood values which are likelihood values calculated with the use of an acoustic model and language model written in a recognition dictionary of the recognition dictionary database memory 2 are 10 for a function name “search for convenience stores” and 0 for a function name “search for family restaurants”. “Search for convenience stores” is therefore output as the most probable function name. A phrase between the directional quotation marks “ ” is a recognition result.

FIG. 7 is an example of a conversion database saved in the key conversion database memory 7 which is used to determine files of rearranged shortcut keys to be displayed in the display means 6 which is internal processing of the shortcut key rearranging means 3 of the first embodiment. The operation of the shortcut key rearranging means 3 is described in detail below with reference to FIG. 7.

In FIG. 7, when a function name input to the display means 6 is “search for convenience stores”, for example, a shortcut key file name that corresponds thereto is 00000001.jpg, and this file (in the example, a rectangular frame icon with “convenience store” written therein which is illustrated in a lower part of FIG. 7) is output to be displayed as a shortcut key on the display screen.

According to the first embodiment where the means and memories described above are provided, shortcut keys are arranged on the display screen, and a resultant effect is that a function can be executed without a transition to a deeper hierarchy level via button operation.

Another effect is that executing a function that is not intended by the user due to false recognition or the like is prevented because a function is executed when the user ultimately presses one of the shortcut keys, as opposed to the case where a function is executed by voice-activated operation.

### Second Embodiment

In a second embodiment, an erasure time limit which is the length of time till a shortcut key displayed on the display screen is erased is calculated for each shortcut key based on the number of times the shortcut key has been chosen, and a shortcut key is erased when the duration of appearance of the shortcut key reaches the shortcut key's erasure time limit.

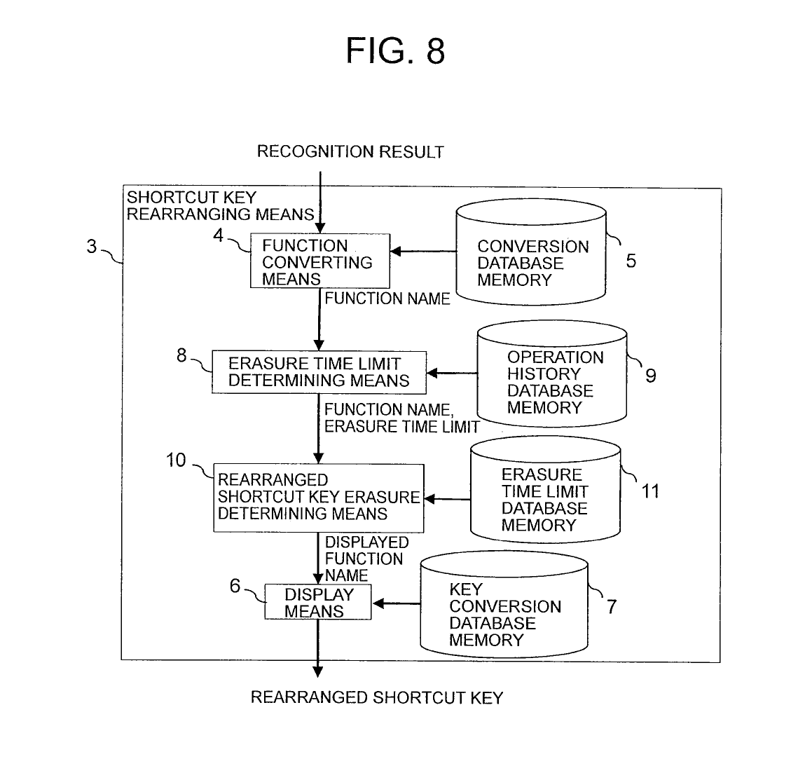

FIG. 8 is a configuration diagram illustrating shortcut key rearranging means 3 according to the second embodiment of the present invention. The overall configuration of the main components of an invention of an information equipment according to the second embodiment of the present invention is as illustrated in FIG. 2, and the second embodiment differs from the first embodiment only in the internal configuration of the shortcut key rearranging means 3.

The shortcut key rearranging means 3 in FIG. 8 includes the function converting means 4, the conversion database memory 5, erasure time limit determining means 8, an operation history database memory 9, rearranged shortcut key erasure determining means 10, an erasure time limit database memory 11, the display means 6, and the key conversion database memory 7.

The function converting means 4, the conversion database memory 5, the display means 6, and the key conversion database memory 7 are the same as those in the first embodiment, and descriptions thereof are omitted here.

The erasure time limit determining means 8 refers to the operation history database memory 9, calculates an erasure time limit DTn based on CC, which is the number of times a function name input thereto has been chosen (hereinafter referred to as chosen count), by the following Expression (2), and outputs DTn.

[Math. 2]

DTn=CC×DT0×HP (2)

DTn: the length of time till a shortcut key is erased (hereinafter referred to as erasure time limit)

DT0: an initial erasure time limit

HP: a displayed time normalizing parameter

An optimum value obtained in an advance simulation is used as the displayed time normalizing parameter HP.

The operation history database memory 9 is a memory for storing a database in which the association between a function name and a chosen count is written in order to determine the erasure time limit from a function name. In other words, the operation history database memory 9 is built to have a table structure that stores a plurality of pieces of conversion information each of which indicates the association between a function name and a chosen count.

The rearranged shortcut key erasure determining means 10 is means for receiving a function name and the erasure time limit DTn calculated by the erasure time limit determining means 8 as inputs, and outputting a displayed function name.

The erasure time limit database memory 11 is a memory for storing a database in which the association between a function name, a displayed time, and an erasure time limit is written in order to determine a displayed function name from a function name and the erasure time limit. In other words, the erasure time limit database memory 11 is built to have a table structure that stores a plurality of pieces of conversion information.

How the information equipment operates is described next.

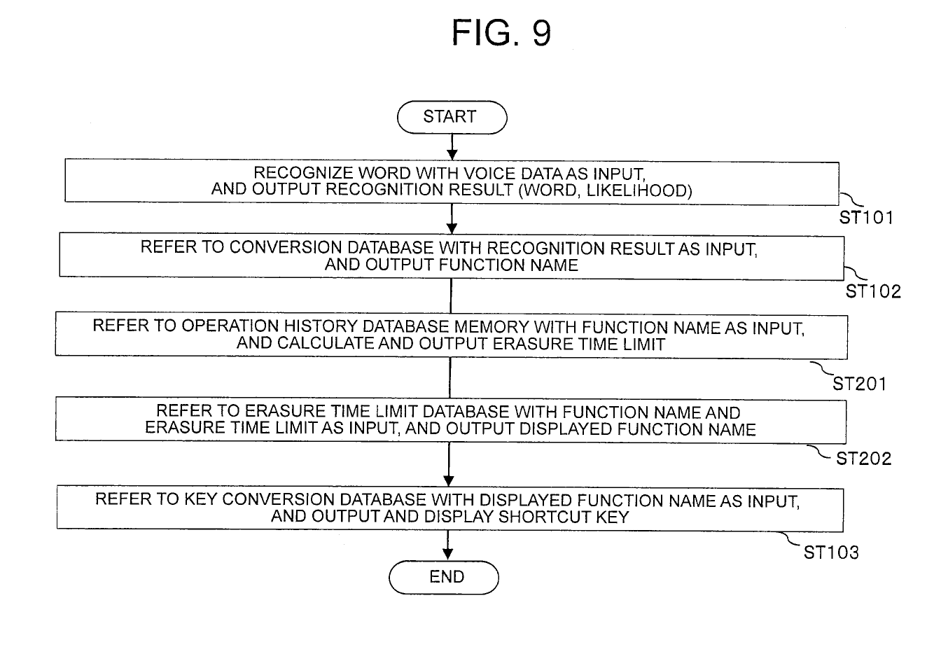

FIG. 9 is a flow chart illustrating the operation of the information equipment of the second embodiment.

The specifics of Steps ST101 to ST103 illustrated in FIG. 9 are the same as those of Steps ST101 to ST103 in the first embodiment, and descriptions thereof are omitted here.

A function name that is the output of the function converting means 4 is input to the erasure time limit determining means 8, and the erasure time limit determining means 8 uses Expression (2) to calculate and output the erasure time limit DTn as described above (Step ST201).

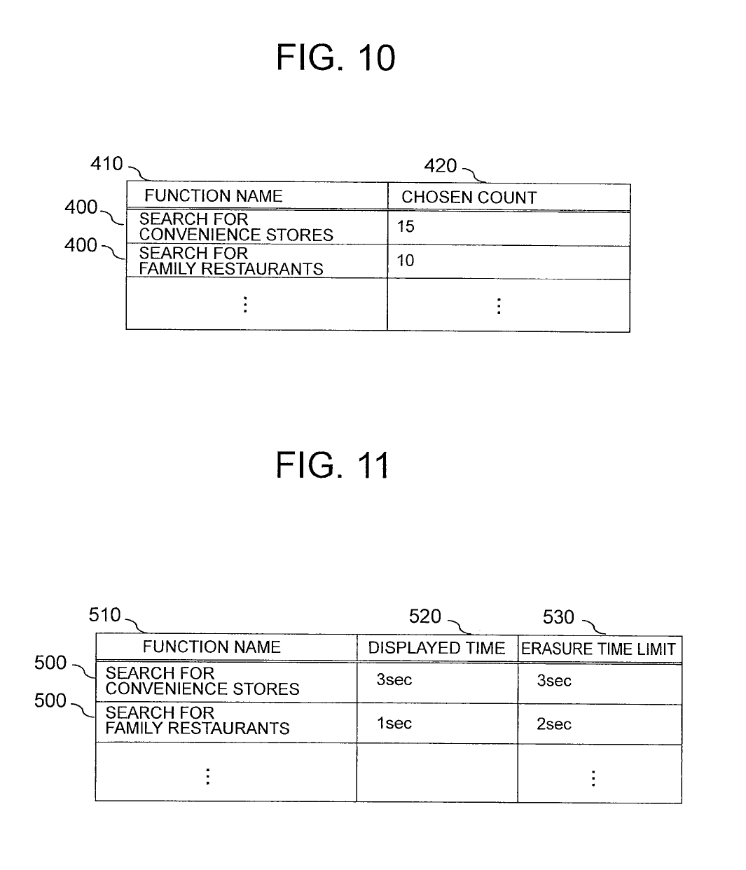

FIG. 10 is an explanatory diagram of the operation history database 9 which is used to calculate the erasure time limit DTn in the erasure time limit determining means 8 of the second embodiment. The operation of the erasure time limit determining means 8 is described in detail below with reference to FIG. 10.

In FIG. 10, when a function name input to the erasure time limit determining means 8 is “search for convenience stores”, for example, if the chosen count CC is 15, the initial erasure time limit DT0 is 2 seconds, and the displayed time normalizing parameter HP which is a parameter for adjusting the displayed time so that a shortcut key is displayed long enough to be recognizable to the human eye is 1/10, a value “3 seconds” is output as the erasure time limit DTn calculated by Expression (2).

A function name and an erasure time limit that are the output of the erasure time limit determining means 8 are input to the rearranged shortcut key erasure determining means 10 and, when the displayed time becomes equal to or more than the erasure time limit, the rearranged shortcut key erasure determining means 10 erases the target shortcut key from the rearrangement result and outputs function names remaining after the erasure (displayed function names) (Step ST202).

FIG. 11 is an explanatory diagram of the erasure time limit database memory 11 which is used to determine a displayed function name in the rearranged shortcut key erasure determining means 10. The operation of the rearranged shortcut key erasure determining means 10 is described in detail below with reference to FIG. 11.

In FIG. 11, when a function name “search for convenience stores” and an erasure time limit “3 seconds” are input to the rearranged shortcut key erasure determining means 10, for example, the rearranged shortcut key erasure determining means 10 refers to the erasure time limit database memory 11 to find out that a displayed time that is associated with “search for convenience stores” is 3 seconds, which is equal to or more than the erasure time limit. The rearranged shortcut key erasure determining means 10 therefore outputs as a displayed function name only “search for family restaurants” which is a function name whose displayed time stored in the erasure time limit database memory 11 is within the erasure time limit.

According to the second embodiment where the erasure time limit determining means 8, the rearranged shortcut key erasure determining means 10, the operation history database memory 9, and the erasure time limit database memory 11 are provided, other shortcut keys than ones that are high in chosen count tend to be erased in a short period of time from the limited space of the display screen. A resultant effect is that selecting a shortcut key is made easy for the user.

### Third Embodiment

In a third embodiment, an erasure time limit which is the length of time till a shortcut key displayed on the display screen is erased is calculated for each shortcut key based on the number of times the shortcut key has been displayed, and a shortcut key is erased when the duration of appearance of the shortcut key reaches the shortcut key's erasure time limit.

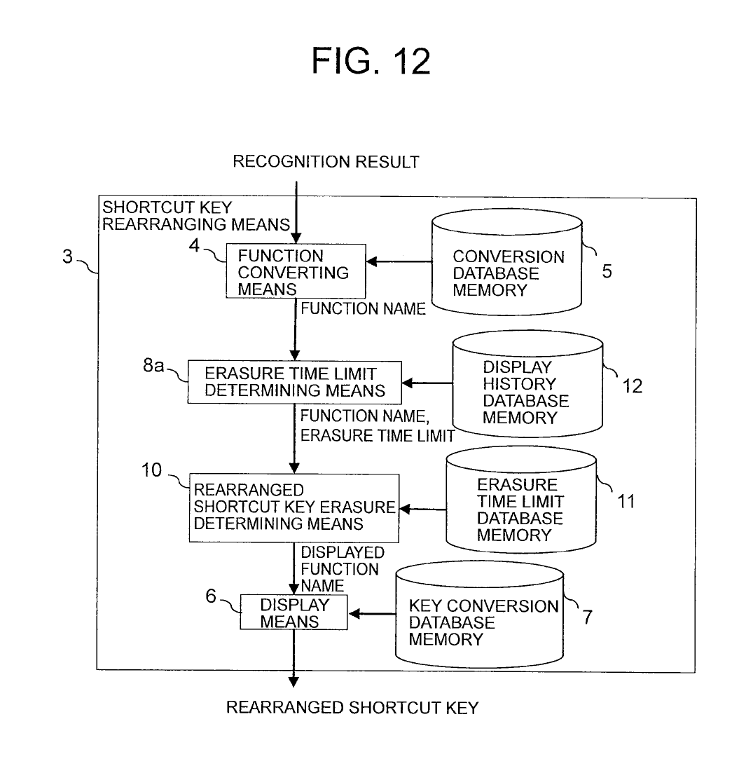

FIG. 12 is a configuration diagram illustrating shortcut key rearranging means 3 according to the third embodiment of the present invention. The overall configuration of the main components of an information equipment according to the third embodiment of the present invention is as illustrated in FIG. 2, and the third embodiment differs from the first embodiment only in the internal configuration of the shortcut key rearranging means 3.

The shortcut key rearranging means 3 in FIG. 12 includes the function converting means 4, the conversion database memory 5, erasure time limit determining means 8a, a display history database memory 12, the rearranged shortcut key erasure determining means 10, the erasure time limit database memory 11, the display means 6, and the key conversion database memory 7.

The function converting means 4, the conversion database memory 5, the display means 6, and the key conversion database memory 7 are the same as those in the first embodiment. The rearranged shortcut key erasure determining means 10 and the erasure time limit database memory 11 are the same as those in the second embodiment. Descriptions thereof are therefore omitted here.

A function name is input from the conversion determining means 4 to the erasure time limit determining means 8a. The erasure time limit determining means 8a refers to the display history database memory 12, calculates the erasure time limit DTn based on the chosen count CC and from AC, which is the number of times a shortcut key has been displayed (hereinafter referred to as displayed count), by the following Expression (3), and outputs DTn.

[Math. 3]

DTn=(CC|AC)×DT0×HP (3)

DTn: an erasure time limit

DT0: an initial erasure time limit

HP: a displayed time normalizing parameter

The display history database memory 12 is a memory for storing a database in which the association between a function name, a displayed count, and a chosen count is written in order to determine the erasure time limit from a function name. In other words, the display history database memory 12 is built to have a table structure that stores a plurality of pieces of conversion information.

How the information equipment operates is described next.

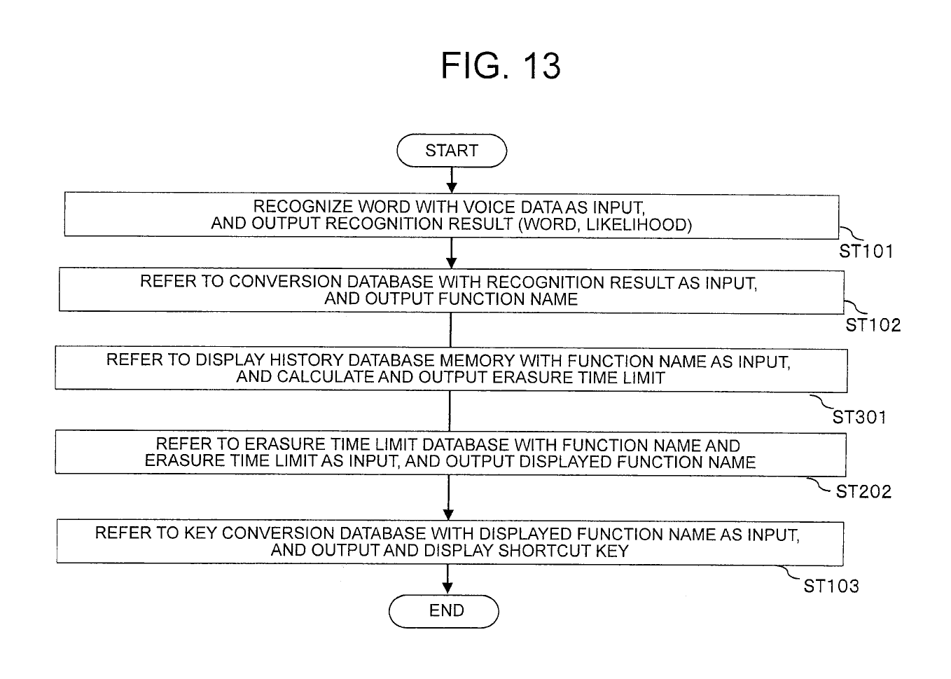

FIG. 13 is a flow chart illustrating the operation of the information equipment of the third embodiment.

The specifics of Steps ST101 to ST103 and ST202 illustrated in FIG. 13 are the same as those of Steps ST101 to ST103 and ST202 in the second embodiment, and descriptions thereof are omitted here.

A function name that is the output of the function converting means 4 is input to the erasure time limit determining means 8a, and the erasure time limit determining means 8a uses Expression (3) to calculate and output the erasure time limit as described above (Step ST301).

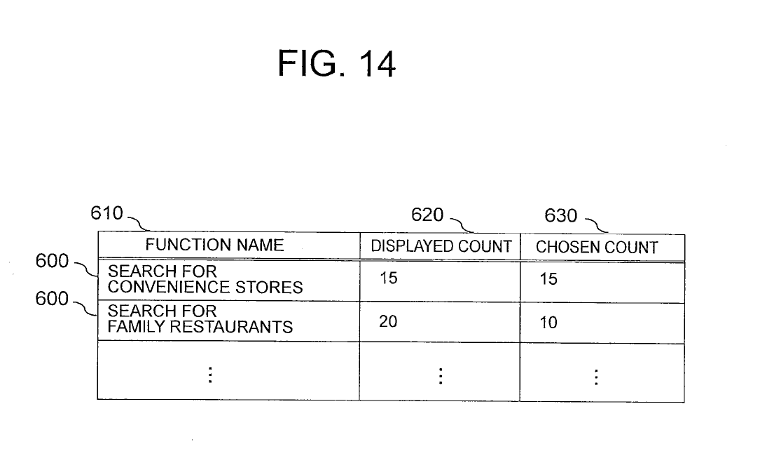

FIG. 14 is an explanatory diagram of the display history database 12 which is used to calculate the erasure time limit in the erasure time limit determining means 8a of the third embodiment. The operation of the erasure time limit determining means 8a is described in detail below with reference to FIG. 14.

In FIG. 14, when a function name input to the erasure time limit determining means 8a is “search for convenience stores”, for example, if the displayed count AC is 15, the chosen count CC is 15, the initial erasure time limit DT0 is 2 seconds, and the displayed time normalizing parameter HP which is a parameter for adjusting the displayed time so that a shortcut key is displayed long enough to be recognizable to the human eye is 1, a value “2 seconds” is output as the erasure time limit DTn calculated by Expression (3).

According to the third embodiment where the erasure time limit determining means 8a and the display history database memory 12 are provided, other shortcut keys than ones that are high in chosen count as compared with the displayed count tend to be erased in a short period of time from the limited space of the display screen. A resultant effect is that selecting a shortcut key is made easy for the user.

### Fourth Embodiment

In a fourth embodiment, an erasure time limit which is the length of time till a shortcut key displayed on the display screen is erased is calculated for each shortcut key based on recognition result likelihood, and a shortcut key is erased when the duration of appearance of the shortcut key reaches the shortcut key's erasure time limit.

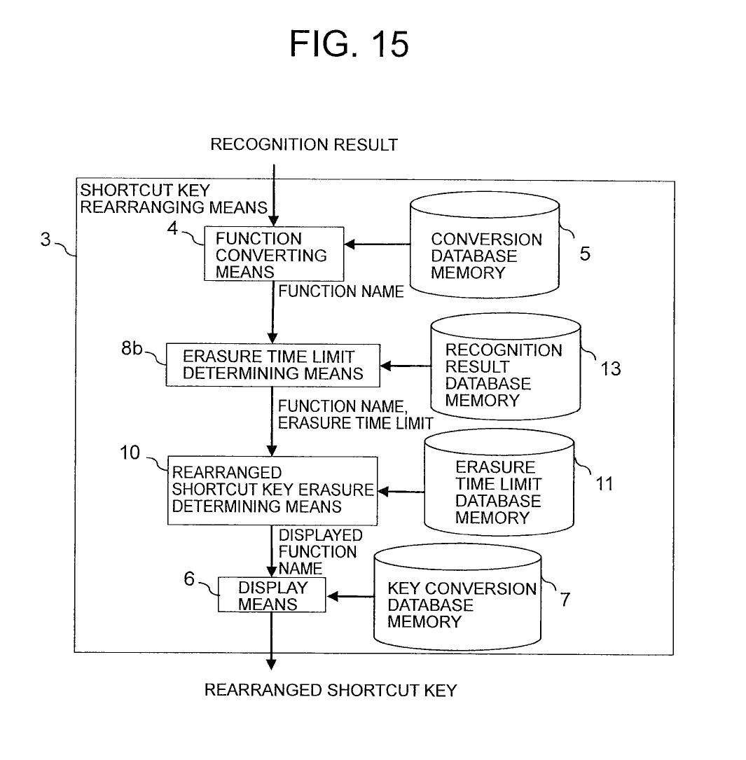

FIG. 15 is a configuration diagram illustrating shortcut key rearranging means 3 according to the fourth embodiment of the present invention. The overall configuration of the main components of an invention of an information equipment according to the fourth embodiment of the present invention is as illustrated in FIG. 2, and the fourth embodiment differs from the first embodiment only in the internal configuration of the shortcut key rearranging means 3.

The shortcut key rearranging means 3 in FIG. 15 includes the function converting means 4, the conversion database memory 5, erasure time limit determining means 8b, a recognition result database memory 13, the rearranged shortcut key erasure determining means 10, the erasure time limit database memory 11, the display means 6, and the key conversion database memory 7.

The function converting means 4, the conversion database memory 5, the display means 6, and the key conversion database memory 7 are the same as those in the first embodiment, and descriptions thereof are therefore omitted here. The rearranged shortcut key erasure determining means 10 and the erasure time limit database memory 11 are the same as those in the second embodiment. Descriptions thereof are therefore omitted here as well.

The erasure time limit determining means 8b refers to the recognition result database memory 13, and a function name is input to the erasure time limit determining means 8b. The erasure time limit determining means 8b then calculates the erasure time limit DTn based on a recognition result likelihood value RL by the following Expression (4), and outputs DTn.

[Math. 4]

DTn=RL×DT0×HP (4)

DTn: the length of time till a shortcut key is erased (hereinafter referred to as erasure time limit)

DT0: an initial erasure time limit

HP: a displayed time normalizing parameter

The recognition result database memory 13 is a memory for storing a database in which the association between a function name and a recognition result likelihood value is written in order to determine the erasure time limit from a function name. In other words, the recognition result database memory 13 is built to have a table structure that stores a plurality of pieces of conversion information.

How the information equipment operates is described next.

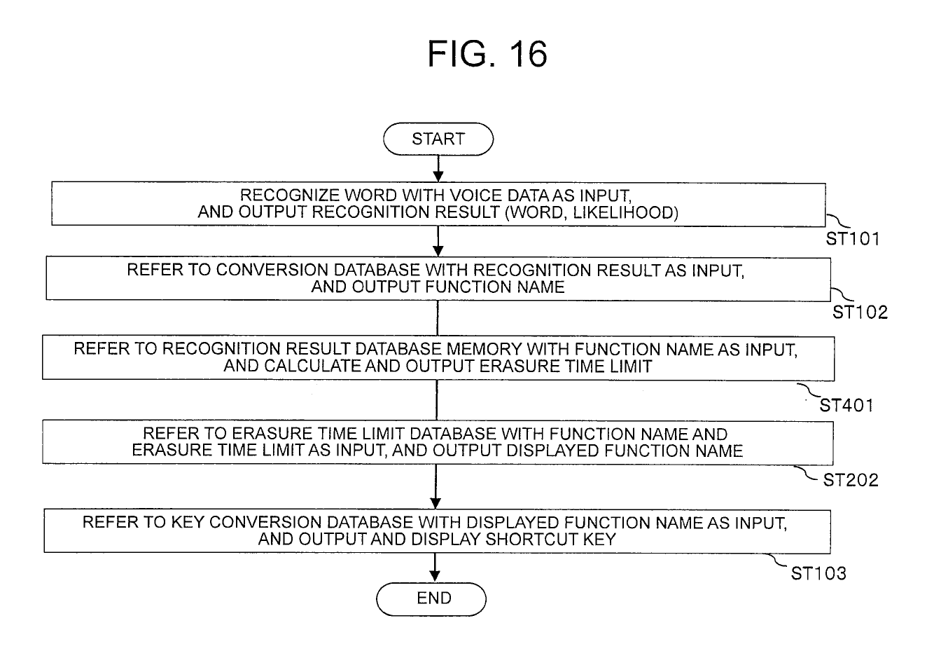

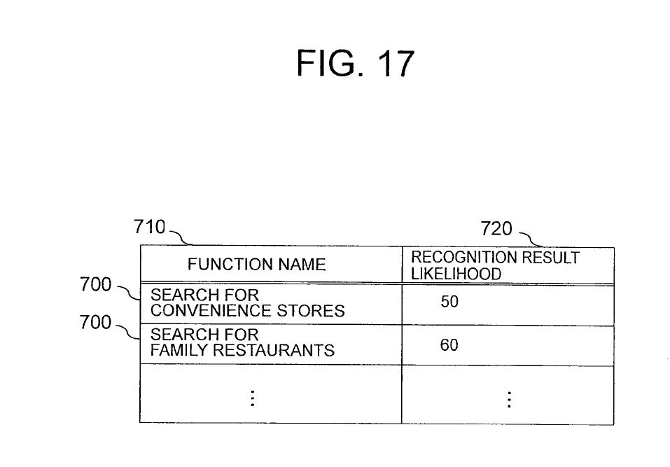

FIG. 16 is a flow chart illustrating the operation of the information equipment of the fourth embodiment.

The specifics of Steps ST101 to ST103 and ST202 illustrated in FIG. 16 are the same as those of Steps ST101 to ST103 and ST202 in the second embodiment, and descriptions thereof are omitted here.

A function name that is the output of the function converting means 4 is input to the erasure time limit determining means 8b, and the erasure time limit determining means 8b uses Expression (4) to calculate and output the erasure time limit DTn as described above (Step ST401).

FIG. 17 is an explanatory diagram illustrating an example of the contents of the recognition result database memory 13 which is used to calculate the erasure time limit DTn in the erasure time limit determining means 8b of the fourth embodiment. The operation of the erasure time limit determining means 8b is described in detail below with reference to FIG. 17.

In FIG. 17, when a function name input to the erasure time limit determining means 8b is “search for convenience stores”, for example, if the recognition result likelihood value RL is 50, the initial erasure time limit DT0 is 2 seconds, and the displayed time normalizing parameter HP which is a parameter for adjusting the displayed time so that a shortcut key is displayed long enough to be recognizable to the human eye is 1/25, a value “4 seconds” is output as the erasure time limit DTn calculated by Expression (4).

According to the fourth embodiment where the erasure time limit determining means 8b and the recognition result database memory 13 are provided, other shortcut keys than ones that are high in recognition likelihood tend to be erased in a short period of time from the limited space of the display screen. A resultant effect is that selecting a shortcut key is made easy for the user.

### Fifth Embodiment

In a fifth embodiment, an erasure time limit which is the length of time till a shortcut key displayed on the display screen is erased is calculated for each shortcut key based on a recognized count, and a shortcut key is erased when the duration of appearance of the shortcut key reaches the shortcut key's erasure time limit.

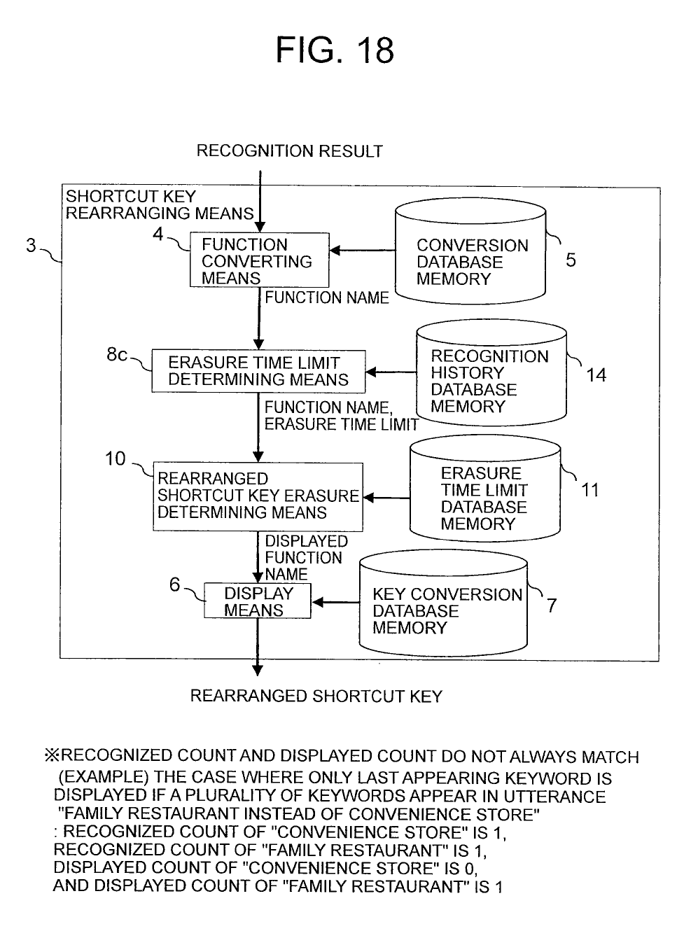

FIG. 18 is a configuration diagram illustrating shortcut key rearranging means 3 according to the fifth embodiment of the present invention. The overall configuration of the main components of an invention of an information equipment according to the fifth embodiment of the present invention is as illustrated in FIG. 2, and the fifth embodiment differs from the first embodiment only in the internal configuration of the shortcut key rearranging means 3.

The shortcut key rearranging means 3 in FIG. 18 includes the function converting means 4, the conversion database memory 5, erasure time limit determining means 8c, a recognition history database memory 14, the rearranged shortcut key erasure determining means 10, the erasure time limit database memory 11, the display means 6, and the key conversion database memory 7.

The function converting means 4, the conversion database memory 5, the display means 6, and the key conversion database memory 7 are the same as those in the first embodiment, and descriptions thereof are therefore omitted here. The rearranged shortcut key erasure determining means 10 and the erasure time limit database memory 11 are the same as those in the second embodiment. Descriptions thereof are therefore omitted here as well.

The erasure time limit determining means 8c refers to the recognition history database memory 14, and a function name is input to the erasure time limit determining means 8c. The erasure time limit determining means 8c then calculates the erasure time limit DTn based on a recognized count RC by the following Expression (5), and outputs DTn.

[Math. 5]

DTn=RC×DT0×HP (5)

DTn: the length of time till a shortcut key is erased (hereinafter referred to as erasure time limit)

DT0: an initial erasure time limit

HP: a displayed time normalizing parameter

The recognition history database memory 14 is a memory for storing a database in which the association between a function name and a recognized count is written in order to determine the erasure time limit from a function name. In other words, the recognition history database memory 14 is built to have a table structure that stores a plurality of pieces of conversion information.

How the information equipment operates is described next.

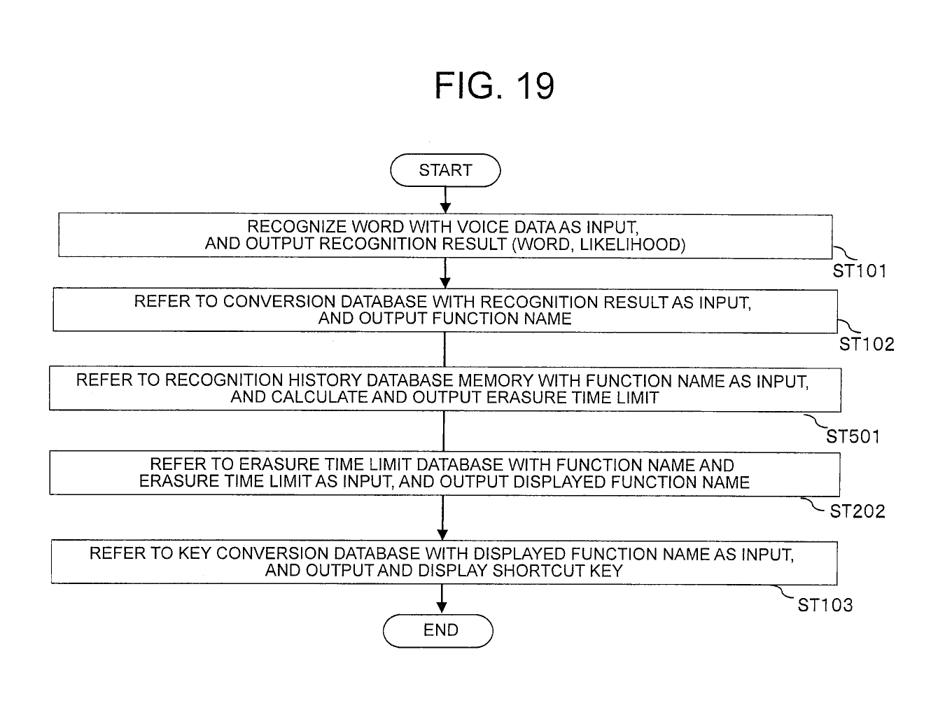

FIG. 19 is a flow chart illustrating the operation of the information equipment of the fifth embodiment.

The specifics of Steps ST101 to ST103 and ST202 illustrated in FIG. 19 are the same as those of Steps ST101 to ST103 and ST202 in the second embodiment, and descriptions thereof are omitted here.

A function name that is the output of the function converting means 4 is input to the erasure time limit determining means 8c, and the erasure time limit determining means 8c uses Expression (5) to calculate and output the erasure time limit DTn as described above (Step ST501).

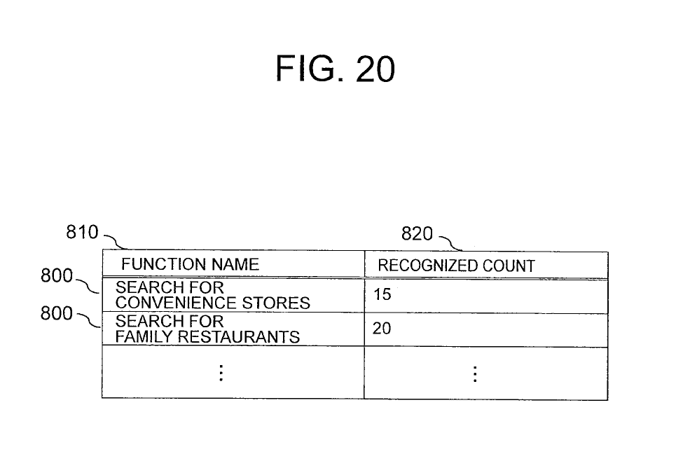

FIG. 20 is an explanatory diagram illustrating an example of the contents of the recognition history database memory 14 which is used to calculate the erasure time limit in the erasure time limit determining means 8c of the fifth embodiment. The operation of the erasure time limit determining means 8c is described in detail below with reference to FIG. 20.

In FIG. 20, when a function name input to the erasure time limit determining means 8c is “search for convenience stores”, for example, if the recognized count RC is 15, the initial erasure time limit DT0 is 2 seconds, and the displayed time normalizing parameter HP which is a parameter for adjusting the displayed time so that a shortcut key is displayed long enough to be recognizable to the human eye is 1/15, a value “2 seconds” is output as the erasure time limit DTn calculated by Expression (5).

According to the fifth embodiment where the erasure time limit determining means 8 and the recognition history database memory 14 are provided, other shortcut keys than ones that are high in recognized count tend to be erased in a short period of time from the limited space of the display screen. A resultant effect is that selecting a shortcut key is made easy for the user.

### Sixth Embodiment

In a sixth embodiment, an erasure time limit which is the length of time till a shortcut key displayed on the display screen is erased is calculated for each shortcut key based on a state maintaining time of a current state, and a shortcut key is erased when the duration of appearance of the shortcut key on the display screen reaches the shortcut key's erasure time limit.

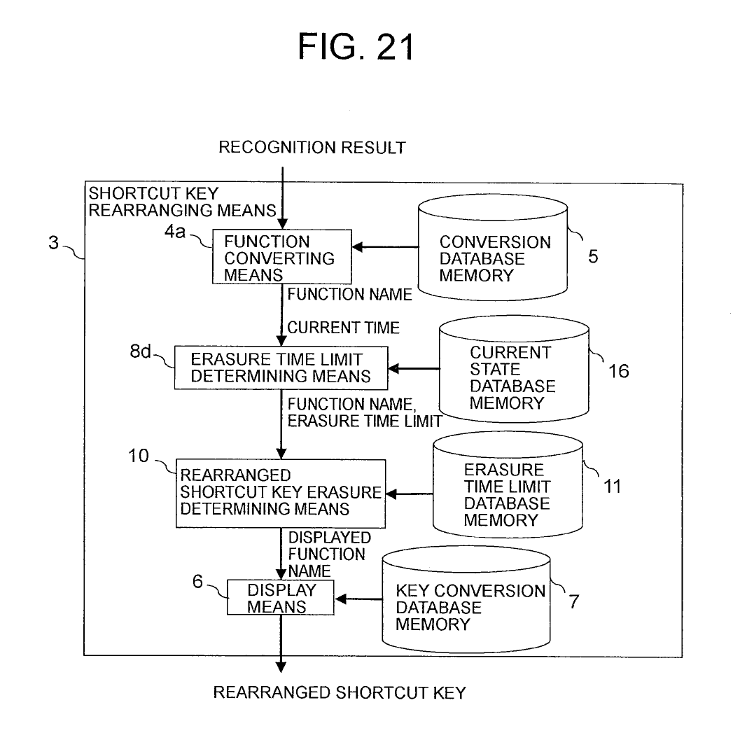

FIG. 21 is a configuration diagram illustrating shortcut key rearranging means 3 according to the sixth embodiment of the present invention. The overall configuration of the main components of an invention of an information equipment according to the sixth embodiment of the present invention is as illustrated in FIG. 2, and the sixth embodiment differs from the first embodiment only in the internal configuration of the shortcut key rearranging means 3.

The shortcut key rearranging means 3 in FIG. 21 includes the function converting means 4, the conversion database memory 5, erasure time limit determining means 8d, a current state database memory 16, the rearranged shortcut key erasure determining means 10, the erasure time limit database memory 11, the display means 6, and the key conversion database memory 7.

The function converting means 4, the conversion database memory 5, the display means 6, and the key conversion database memory 7 are the same as those in the first embodiment, and descriptions thereof are therefore omitted here. The rearranged shortcut key erasure determining means 10 and the erasure time limit database memory 11 are the same as those in the second embodiment. Descriptions thereof are therefore omitted here as well.

The erasure time limit determining means 8d refers to the current state database memory 16, and a function name is input to the erasure time limit determining means 8d. Then, the erasure time limit determining means 8d outputs the erasure time limit.

The current state database memory 16 is a memory for storing a database in which the association between a function name, an erasure time limit, and a state maintaining time is written in order to determine the erasure time limit from a function name. In other words, the current state database memory 16 is built to have a table structure that stores a plurality of pieces of conversion information.

How the information equipment operates is described next.

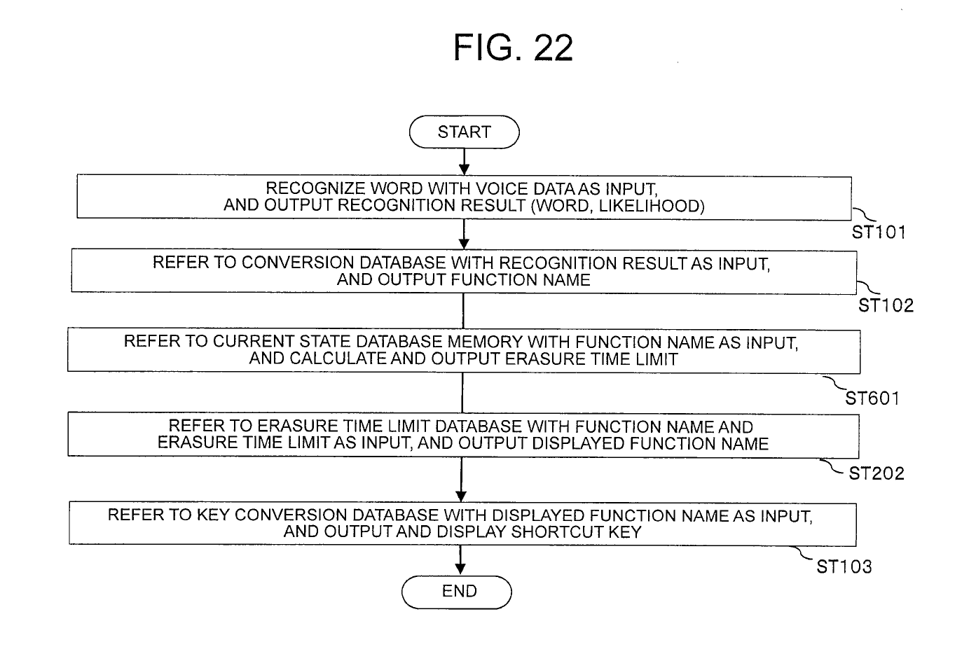

FIG. 22 is a flow chart illustrating the operation of the information equipment of the sixth embodiment.

The specifics of Steps ST101 to ST103 and ST202 illustrated in FIG. 22 are the same as those of Steps ST101 to ST103 and ST202 in the second embodiment, and descriptions thereof are omitted here.

A function name that is the output of the function converting means 4 is input to the erasure time limit determining means 8d, and the erasure time limit determining means 8 calculates and outputs the erasure time limit (Step ST601).

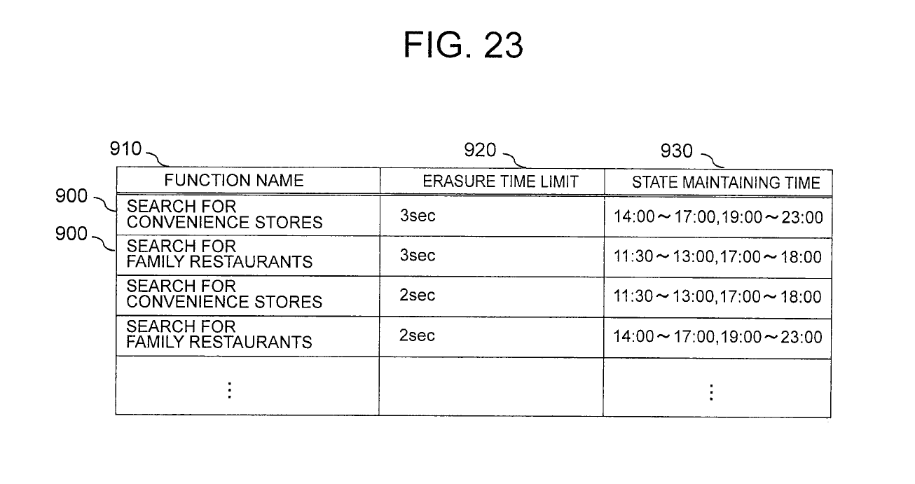

FIG. 23 is an explanatory diagram illustrating an example of the contents of the current state database memory 16 which is used to calculate the erasure time limit in the erasure time limit determining means 8d of the sixth embodiment. The operation of the erasure time limit determining means 8d is described in detail below with reference to FIG. 23.

In FIG. 23, when a function name input to the erasure time limit determining means 8d is “search for convenience stores”, for example, if the current time is 15:00, a value “3 seconds” is output as the erasure time limit.

According to the sixth embodiment where the erasure time limit determining means 8d and the current state database memory 16 are provided, other shortcut keys than ones that are displayed in consideration of the current time tend to be erased in a short period of time from the limited space of the display screen. A resultant effect is that selecting a shortcut key is made easy for the user.

### Seventh Embodiment

In a seventh embodiment, an erasure time limit which is the length of time till a shortcut key displayed on the display screen is erased is calculated for each shortcut key based on a selection transition history, and a shortcut key is erased when the duration of appearance of the shortcut key reaches the shortcut key's erasure time limit.

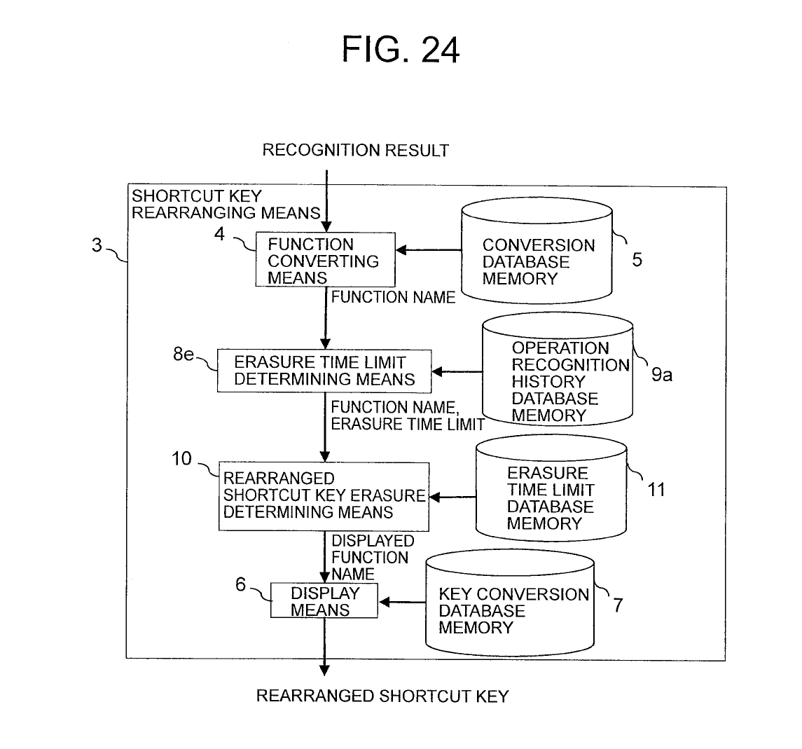

FIG. 24 is a configuration diagram illustrating shortcut key rearranging means 3 according to the seventh embodiment of the present invention. The overall configuration of the main components of an invention of an information equipment according to the seventh embodiment of the present invention is as illustrated in FIG. 2, and the seventh embodiment differs from the first embodiment only in the internal configuration of the shortcut key rearranging means 3.

The shortcut key rearranging means 3 in FIG. 24 includes the function converting means 4, the conversion database memory 5, erasure time limit determining means 8e, an operation recognition history database memory 9a, the rearranged shortcut key erasure determining means 10, the erasure time limit database memory 11, the display means 6, and the key conversion database memory 7.

The function converting means 4, the conversion database memory 5, the display means 6, and the key conversion database memory 7 are the same as those in the first embodiment, and descriptions thereof are therefore omitted here. The rearranged shortcut key erasure determining means 10 and the erasure time limit database memory 11 are the same as those in the second embodiment. Descriptions thereof are therefore omitted here as well.

The erasure time limit determining means 8e refers to the operation recognition history database memory 9a, and a function name is input to the erasure time limit determining means 8e. Then, the erasure time limit determining means 8e calculates the erasure time limit DTn based on a selection transition history parameter SP by the following Expression (6), and outputs DTn.

[Math. 6]

DTn=SP×DT0×HP (6)

DTn: the length of time till a shortcut key is erased (hereinafter referred to as erasure time limit)

DT0: an initial erasure time limit

HP: a displayed time normalizing parameter

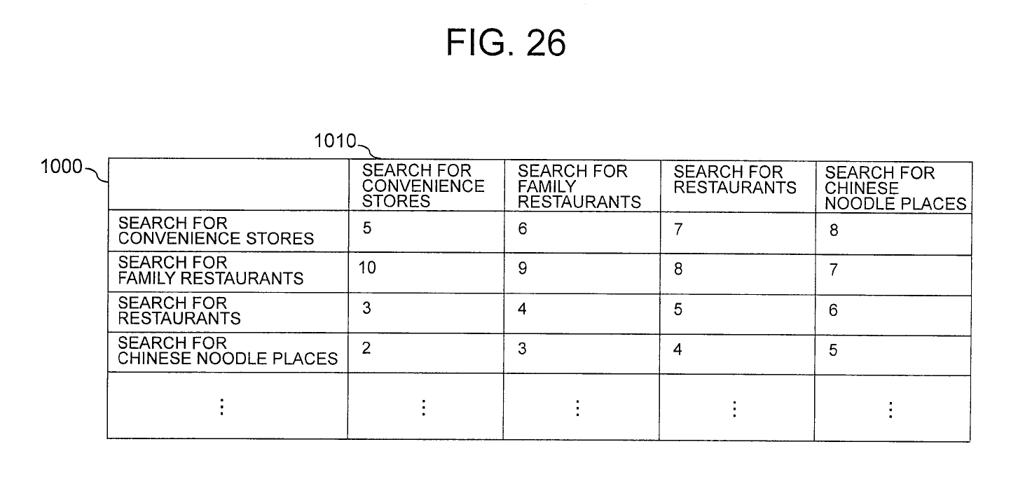

The operation recognition history database memory 9a is a memory for storing a database in which a transition possibility score about a transition between function names is written in order to determine the erasure time limit DTn from a function name. An example of the contents of the database is illustrated in FIG. 26. In FIG. 26, the current function name is written in each row 1000 while the last-operated function name is written in each column 1010, and a corresponding transition possibility score is written at each intersection of a row and a column. For instance, the transition possibility score for selecting “search for family restaurants” the last time and selecting “search for convenience stores” this time is 6.

How the information equipment operates is described next.

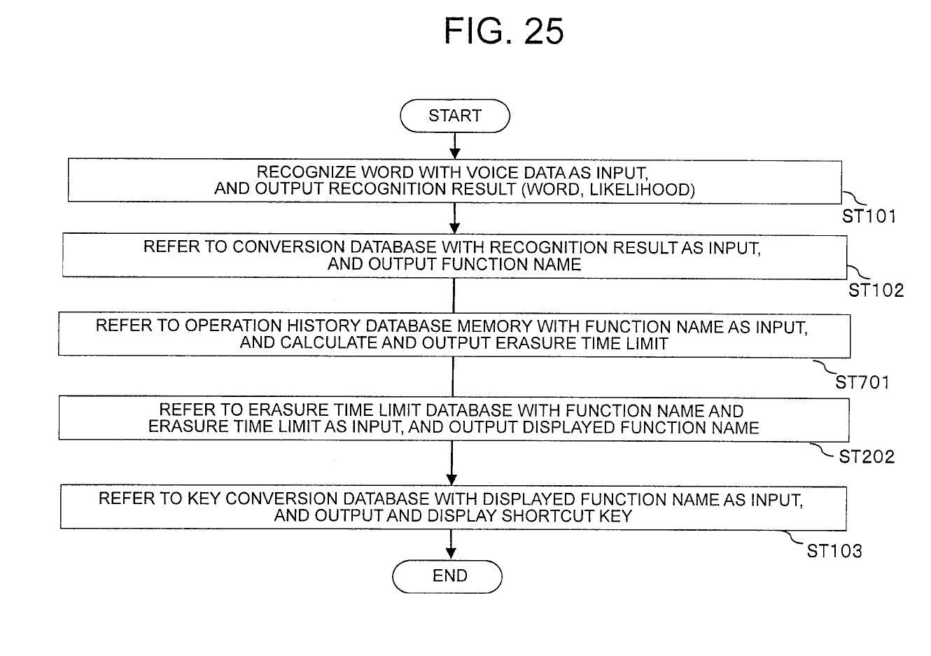

FIG. 25 is a flow chart illustrating the operation of the information equipment of the seventh embodiment.

The specifics of Steps ST101 to ST103 and ST202 illustrated in FIG. 25 are the same as those of Steps ST101 to ST103 and ST202 in the second embodiment.

A function name that is the output of the function converting means 4 is input to the erasure time limit determining means 8e, and the erasure time limit determining means 8e calculates and outputs the erasure time limit (Step ST701).

FIG. 26 is an explanatory diagram of the contents of the operation recognition history database memory 9a which is used to calculate the erasure time limit in the erasure time limit determining means 8e of the seventh embodiment. The operation of the erasure time limit determining means 8e is described in detail below with reference to FIG. 26.

In FIG. 26, when the last-operated function name is “search for family restaurants” and a function name “search for convenience stores” is input to the erasure time limit determining means 8e this time, for example, if the selection transition history parameter SP is 6, the initial erasure time limit DT0 is 2 seconds, and the displayed time normalizing parameter HP which is a parameter for adjusting the displayed time so that a shortcut key is displayed long enough to be recognizable to the human eye is ⅙, a value “2 seconds” is output as the erasure time limit DTn calculated by Expression (6).

According to the seventh embodiment where the erasure time limit determining means 8e and the operation recognition history database memory 9a are provided, other shortcut keys than ones that are displayed in consideration of the context of the past operation on the shortcut keys tend to be erased in a short period of time from the limited space of the display screen. A resultant effect is that selecting a shortcut key is made easy for the user.

As an alternative configuration, two or more combinations of erasure time limit determining means and its corresponding database memory may be selected from among the erasure time limit determining means 8 and 8a to 8e of the second to seventh embodiments and the database memories 9, 12 to 14, and 16 for storing data that is the basis of calculation formulae for determining the erasure time limit in the erasure time limit determining means 8 and 8a to 8e. This configuration uses different data and different calculation formulae to calculate erasure time limits, and calculates and outputs the erasure time limit DTn based on a predetermined standard (e.g., the shortest erasure time limit) in the rearranged shortcut key erasure determining means 10, with the result that a more appropriate erasure time limit is determined.

### Eighth Embodiment

In an eighth embodiment, the importance level is calculated for each shortcut key and a shortcut key is displayed in a place in display order that is determined by the importance level of the shortcut key.

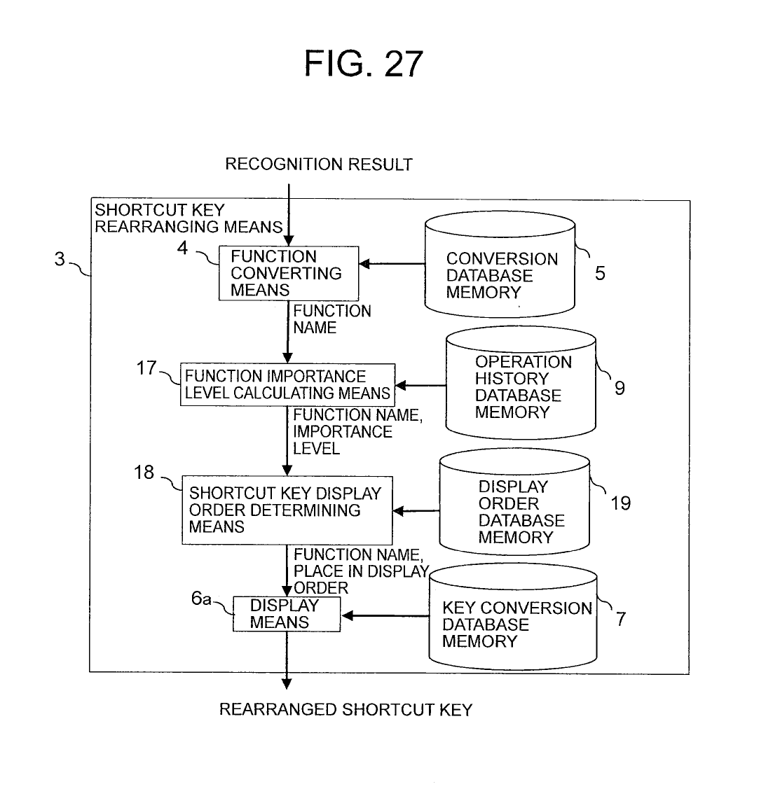

FIG. 27 is a configuration diagram illustrating shortcut key rearranging means 3 according to the eighth embodiment of the present invention. The overall configuration of the main components of an invention of an information equipment according to the eighth embodiment of the present invention is as illustrated in FIG. 2, and the eighth embodiment differs from the first embodiment only in the internal configuration of the shortcut key rearranging means 3.

The shortcut key rearranging means 3 in FIG. 27 includes the function converting means 4, the conversion database memory 5, function importance level calculating means 17, the operation history database memory 9, shortcut key display order determining means 18, a display order database memory 19, display means 6a, and the key conversion database memory 7.

The function converting means 4, the conversion database memory 5, and the key conversion database memory 7 are the same as those in the first embodiment, and descriptions thereof are therefore omitted here. The operation history database memory 9 is the same as the one in the second embodiment as well.

The function importance level calculating means 17 refers to the operation history database memory 9, and a function name is input to the function importance level calculating means 17. Then, the function importance level calculating means 17 calculates and outputs an importance level based on the chosen count CC by the following Expression (7).

[Math. 7]

IPn=CC×IP0×HP (7)

IPn: an importance level

DT0: an initial importance level

HP: a displayed time normalizing parameter

The shortcut key display order determining means 18 is means for receiving a function name and an importance level from the function importance level calculating means 17 as inputs, and referring to the display order database memory 19 to output the function name and a place in display order.

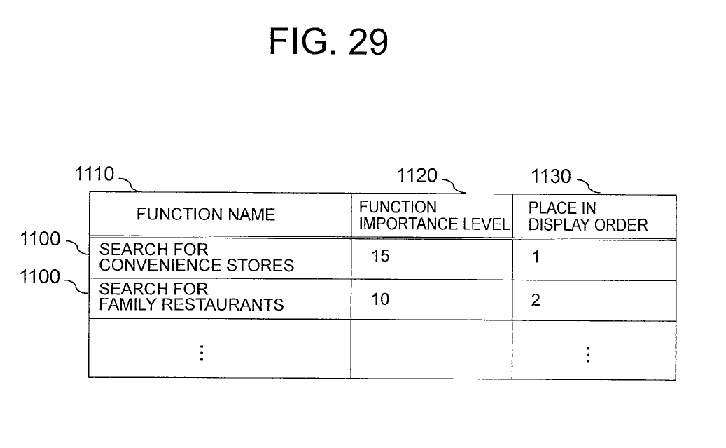

As illustrated in FIG. 29, the display order database memory 19 is a memory for storing a database in which the association between a function name, a function importance level, and a place in display order is written in order to determine the displayed function name from a function name and an erasure time limit. In other words, the display order database memory 19 is built to have a table structure that stores a plurality of pieces of conversion information.

The display means 6a is means for receiving the function name and the place in display order from the shortcut key display order determining means 18 as inputs and referring to the key conversion database 7 to output a rearranged shortcut key that is a shortcut key associated with the function name in the input place in display order. In the case where the input place in display order is already taken by another shortcut key, each currently displayed shortcut key is pushed down by one in display order so that the newly output shortcut key is inserted and displayed.

How the information equipment operates is described next.

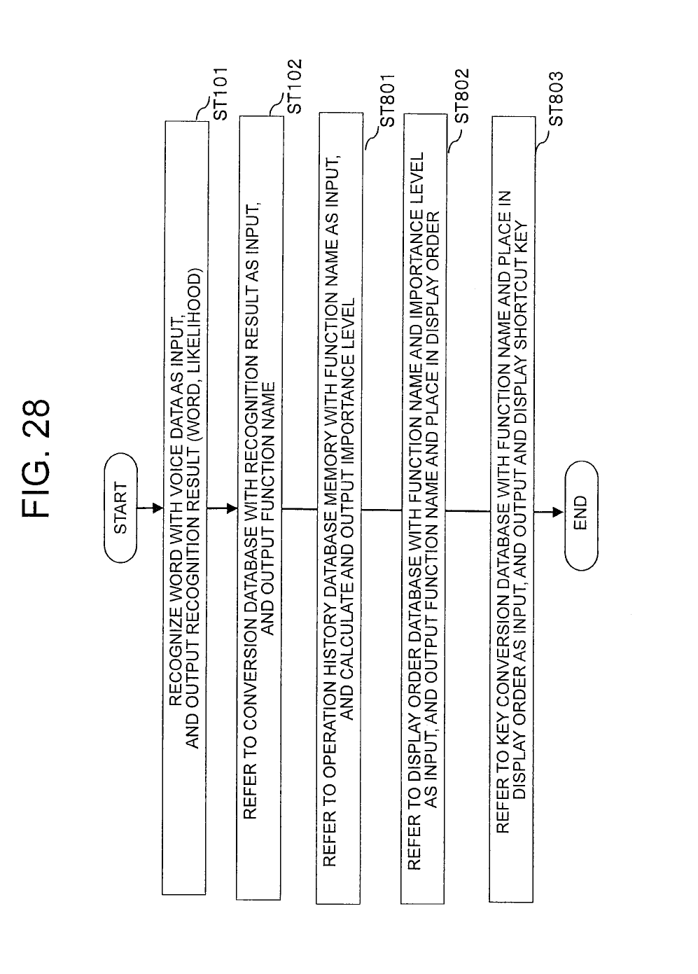

FIG. 28 is a flow chart illustrating the operation of the information equipment of the eighth embodiment.

The specifics of Steps ST101 to ST103 illustrated in FIG. 28 are the same as those of Steps ST101 to ST103 in the first embodiment, and descriptions thereof are omitted here.

The function importance level calculating means 17 refers to the operation history database memory 9, and a function name that is the output of the function converting means 4 is input thereto. The function importance level calculating means 17 then uses Expression (7) to calculate the importance level based on the chosen count CC and outputs the importance level (Step ST801).

The operation history database 9 that is used to calculate the erasure time limit in the function importance level calculating means 17 of the eighth embodiment is the same as the operation history database 9 that is used in the second embodiment in the manner described above and that is illustrated in FIG. 10. The operation of the function importance level calculating means 17 is described in detail below with reference to FIG. 10.

In FIG. 10, when a function name input to the function importance level calculating means 17 is “search for convenience stores”, for example, if the chosen count CC is 15, the initial importance level IP0 is 1, and the displayed time normalizing parameter HP which is a parameter for adjusting the displayed time so that a shortcut key is displayed long enough to be recognizable to the human eye is 1, a value “15” is output as the importance level IPn calculated by Expression (7).

The function name and importance level IPn of 15 output from the function level importance means 17 are input to the shortcut key display order determining means 18, which refers to the display order database memory 19 to determine a place in display order that is associated with the input importance level, and outputs the function name and the place in display order (Step ST802).

FIG. 29 is an explanatory diagram of the contents of the display order database memory 19 which is used to determine a displayed function name in the shortcut key display order determining means 18. The operation of the shortcut key display order determining means 18 is described in detail below with reference to FIG. 29.

In FIG. 29, when a function name “search for convenience stores” and an erasure time limit “3 seconds” are input to the shortcut key display order determining means 18, for example, the shortcut key display order determining means 18 refers to the display order database memory 19 to find out that “search for convenience stores” is higher in importance level than “search for family restaurants” (15>10), and therefore updates the display order database memory 19 by giving 1 as the place in display order of “search for convenience stores” and changing the place in display order of “search for family restaurants” to 2. The shortcut key display order determining means 18 outputs “search for convenience stores” and a place in display order “1”.

The function name and place in display order output from the shortcut key display order determining means 18 are input to the display means 6a, which outputs and displays a relevant shortcut key in the input place in display order (Step ST803).

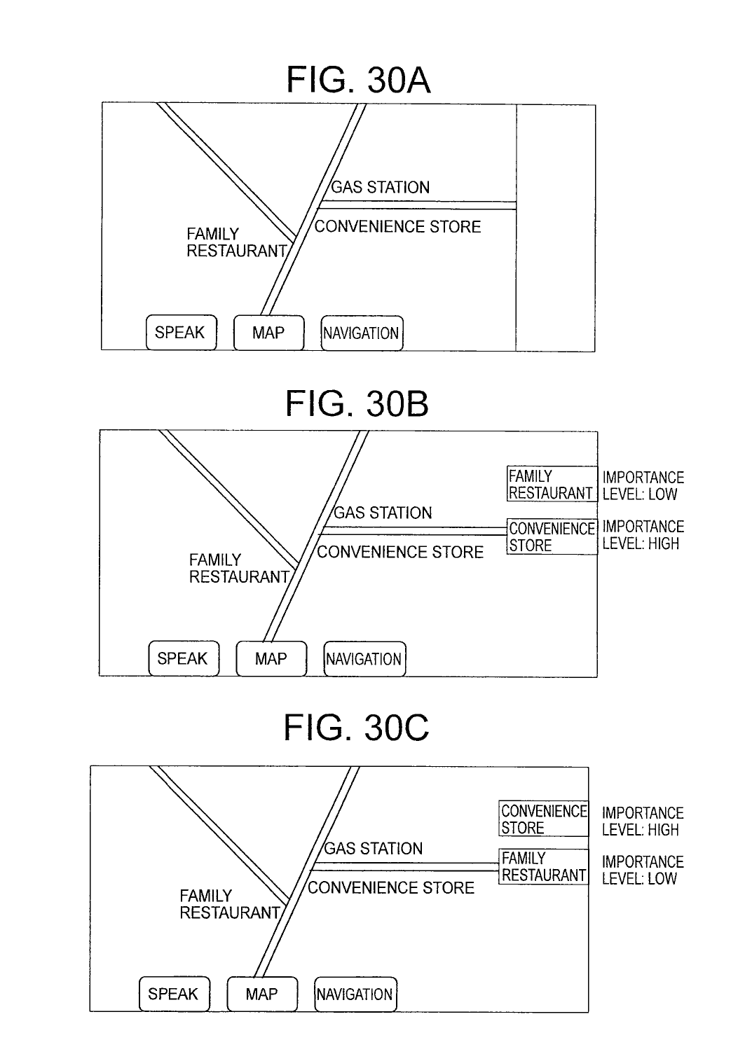

A display example is illustrated in FIG. 30. FIG. 30(A) illustrates the display screen before shortcut key rearrangement. FIG. 30(B) illustrates the display screen after shortcut key rearrangement. FIG. 30(C) illustrates the display screen after a change in shortcut key display order.

According to the eighth embodiment where the function importance level calculating means 17, the shortcut key display order determining means 18, the display order database memory 19, and the display means 6a are provided, shortcut keys are presented to the user in a display order that is determined by the importance level calculated based on the chosen count CC. A resultant effect is that the user can easily choose a desired key by checking shortcut keys in the displayed order.

The configuration and operation discussed in this embodiment is for determining the order in which shortcut keys are displayed on the display screen and for displaying in the determined order. As an alternative configuration, the operation history database memory 9, the function importance level calculating means 17, the shortcut key display order determining means 18, and the display order database memory 19 which are means for determining the order in which shortcut keys are displayed on the display screen in this embodiment may be added to the second to seventh embodiments. In this configuration, the order of displaying shortcut keys on the display screen is determined and shortcut keys are displayed in the determined order, the erasure time limit till a shortcut key is erased is calculated for each of the shortcut keys displayed in the determined display order, and the shortcut key is erased when the calculated erasure time limit is reached. This configuration has the effect of this embodiment in addition to the respective effects of the second to seventh embodiments.

The display means 6 in this case has a function of outputting and displaying shortcut keys in display order in addition to the function of the display means 6 in the second to seventh embodiments. In a combination of the second embodiment and this embodiment, one operation history database memory 9 fulfills both its role in the second embodiment and its role in this embodiment.

### Ninth Embodiment

In a ninth embodiment, the importance level is calculated for each shortcut key and a shortcut key is displayed by a display method that is determined by the importance level of the shortcut key.

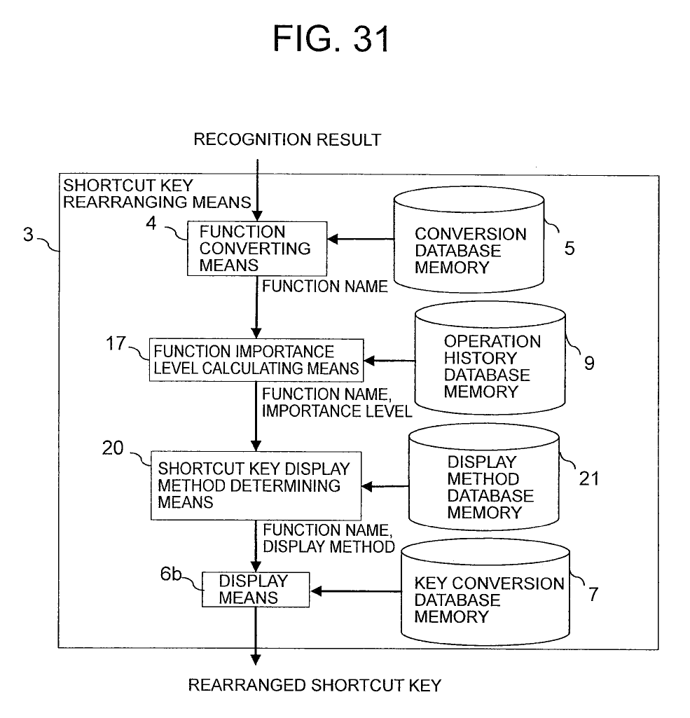

FIG. 31 is a configuration diagram illustrating shortcut key rearranging means 3 according to the ninth embodiment of the present invention. The overall configuration of the main components of an invention of an information equipment according to the ninth embodiment of the present invention is as illustrated in FIG. 2, and the ninth embodiment differs from the first embodiment only in the internal configuration of the shortcut key rearranging means 3.

The shortcut key rearranging means 3 in FIG. 31 includes the function converting means 4, the conversion database memory 5, the function importance level calculating means 17, the operation history database memory 9, shortcut key display method determining means 20, a display method database memory 21, display means 6b, and the key conversion database memory 7.

The function converting means 4, the conversion database memory 5, and the key conversion database memory 7 are the same as those in the first embodiment, and descriptions thereof are therefore omitted here. The function importance level calculating means 17 is the same as the one in the eighth embodiment. A description thereof is therefore omitted here.

The shortcut key display method determining means 20 is means for receiving a function name and an importance level from the importance level calculating means 17 as inputs and referring to the display method database memory 21 to output the function name and a display method.

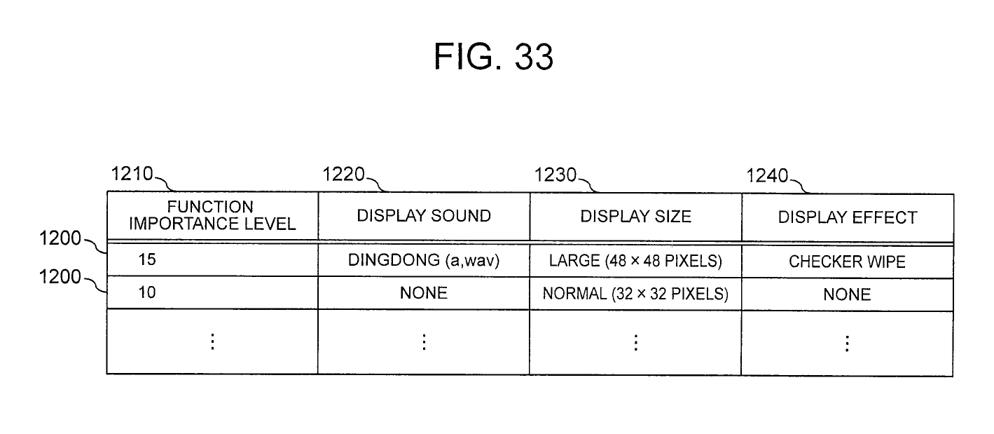

The display method database memory 21 is, as illustrated in FIG. 33, a memory for storing a database in which a function importance level and a display method (elements of a display method in this embodiment are display sound, display size, and display effect) are written. In other words, the display method database memory 21 is built to have a table structure that stores a plurality of pieces of conversion information.

The display means 6b is means for receiving a function importance level and a display method as inputs and referring to the key conversion database 7 to output a rearranged shortcut key that is a shortcut key associated with the input function name in the input display method. In the case where a shortcut key is already in a location where the newly output shortcut key is to be put, the display method of the displayed shortcut key is updated with that of the newly output shortcut key.

How the information equipment operates is described next.

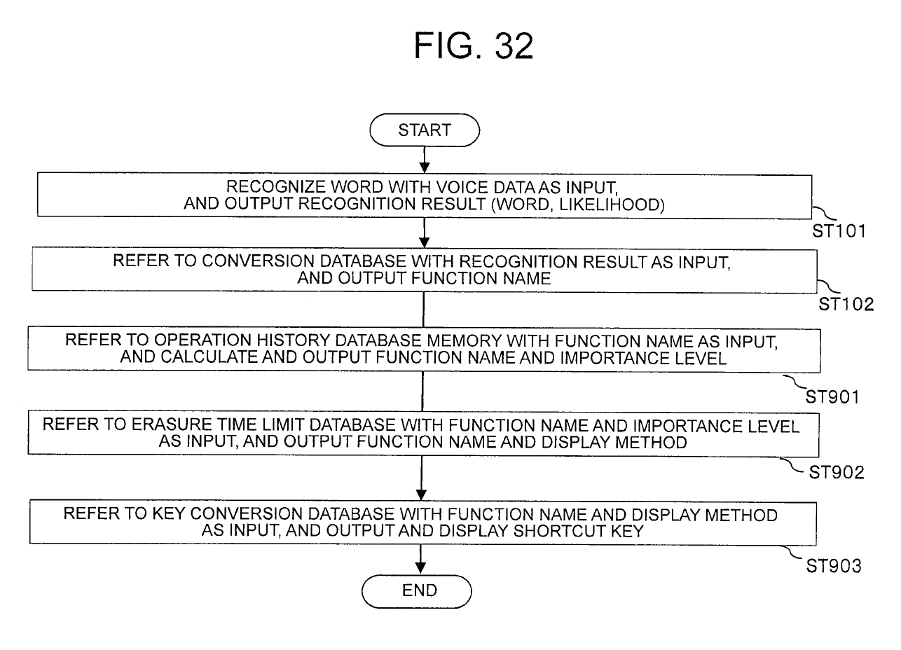

FIG. 32 is a flow chart illustrating the operation of the information equipment of the ninth embodiment.

The specifics of Steps ST101 to ST103 illustrated in FIG. 32 are the same as those of Steps ST101 to ST103 in the first embodiment, and descriptions thereof are omitted here.

A function name that is the output of the function converting means 4 is input to the importance level calculating means 17, which refers to the operation history database memory 9, calculates the importance level based on the chosen count CC by Expression (7), and outputs the importance level as described above (Step ST901).

The function name and importance level output from the function level importance means 17 are input to the shortcut key display method determining means 20, which refers to the display method database memory 21 to determine a display method that is associated with the input importance level, and outputs the function name and the display method stored in the display method database memory 21 (Step ST902).

FIG. 33 illustrates the display method database memory 21 which is used to determine a displayed function name in the shortcut key display method determining means 20. The operation of the shortcut key display method determining means 20 is described in detail below with reference to FIG. 33.

In FIG. 33, when a function name “search for convenience stores” and an importance level “15” are input to the shortcut key display method determining means 20, for example, if the importance level is 15, the shortcut key display method determining means 20 refers to the display method database memory 21 to find out that the importance level of “search for convenience stores” is 15. The shortcut key display method determining means 20 therefore sets a. wav as a sound used when the function name is displayed (display sound), sets the display size to 48×48 pixels, and sets checker wipe display as a display effect. These are output together as a display method.

The function importance level and display method output from the shortcut key display method determining means 20 are input to the display means 6b, which refers to the key conversion database 7 to output and display a relevant shortcut key by the input display method (Step ST903).

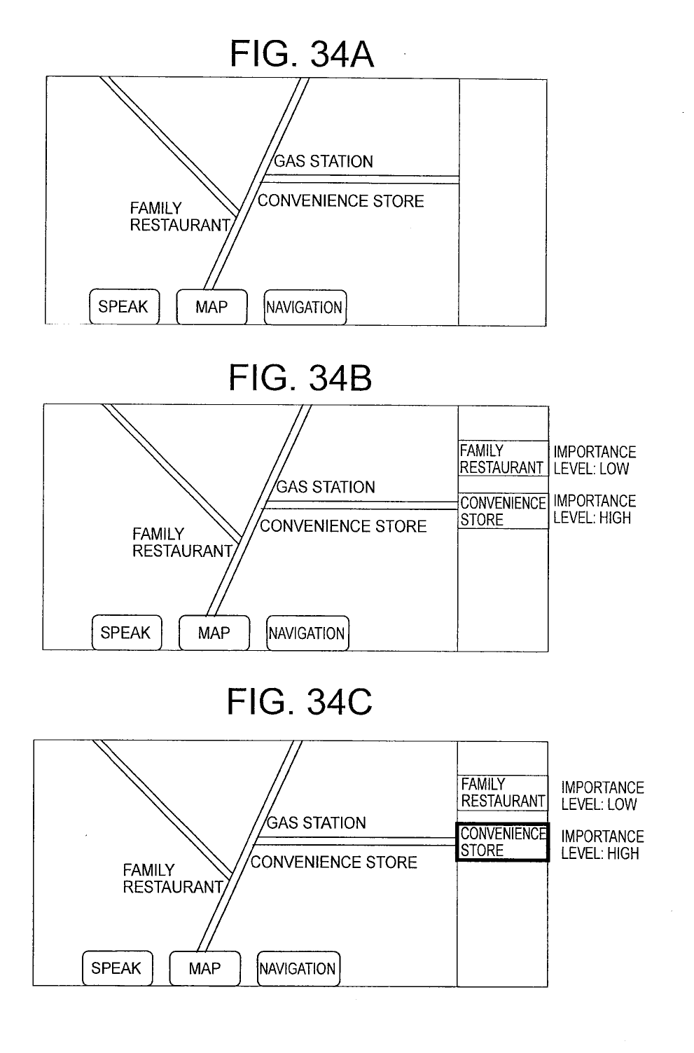

A display example is illustrated in FIG. 34. FIG. 34(A) illustrates the display screen before shortcut key rearrangement. FIG. 30(B) illustrates the display screen after shortcut key rearrangement. FIG. 30(C) illustrates the display screen after a change in shortcut key display method, and the icon for a convenience store is highlighted by bold characters and a thick rectangular frame.

According to the ninth embodiment where the shortcut key display method determining means 20, the display method database memory 21, the display order database memory 19, and the display means 6b are provided, shortcut keys are presented to the user by a display method that is determined by the importance level calculated based on the chosen count. A resultant effect is that the user can easily choose a desired key by checking shortcut keys in order from a highlighted shortcut key.

The configuration and operation discussed in this embodiment is for determining the display method in which shortcut keys are displayed on the display screen and for displaying by the determined method. As an alternative configuration, the operation history database memory 9, the function importance level calculating means 17, the shortcut key display method determining means 20, and the display method database memory 21 which are means for determining the display method in which shortcut keys are displayed on the display screen in this embodiment may be added to the second to seventh embodiments. In this configuration, the method of displaying shortcut keys on the display screen is determined and shortcut keys are displayed by the determined method, the erasure time limit till a shortcut key is erased is calculated for each of the shortcut keys displayed in by the determined display method, and the shortcut key is erased when the calculated erasure time limit is reached. This configuration has the effect of this embodiment in addition to the respective effects of the second to seventh embodiments.

The display means 6 in this case has a function of outputting and displaying shortcut keys by the display method in addition to the function of the display means 6 in the second to seventh embodiments. It should be understood that in a combination of the second embodiment and this embodiment, one operation history database memory 9 fulfills both its role in the second embodiment and its role in this embodiment.

### Tenth Embodiment

In a tenth embodiment, the importance level is calculated for each shortcut key and a shortcut key is displayed in a place in display order that is determined by the importance level of the shortcut key and by a specified display method.

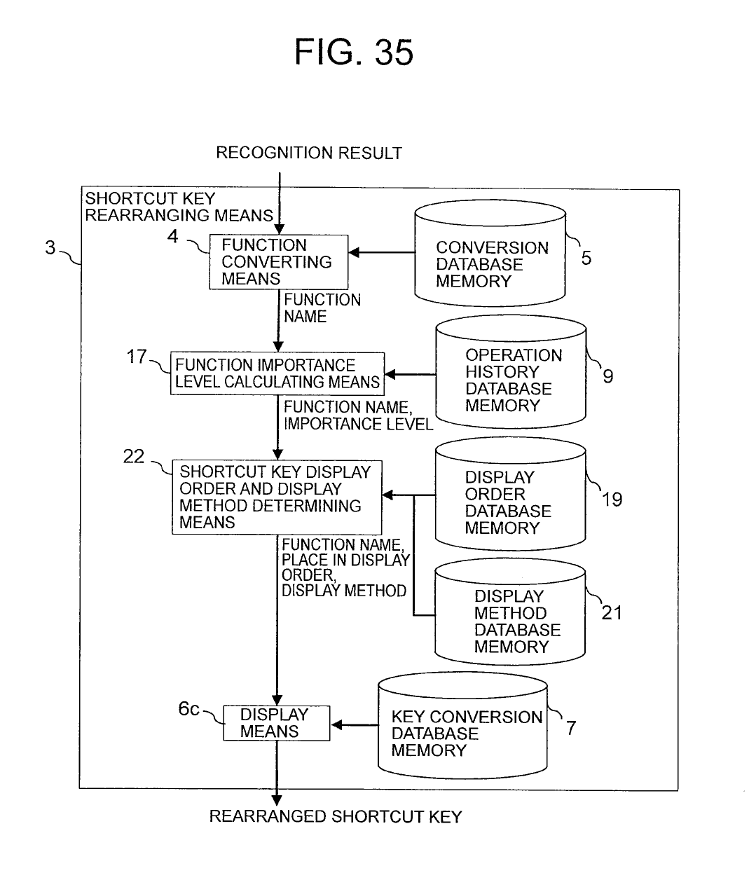

FIG. 35 is a configuration diagram illustrating shortcut key rearranging means 3 according to the tenth embodiment of the present invention. The overall configuration of the main components of an invention of an information equipment according to the tenth embodiment of the present invention is as illustrated in FIG. 2, and the tenth embodiment differs from the first embodiment only in the internal configuration of the shortcut key rearranging means 3.

The shortcut key rearranging means 3 in FIG. 35 includes the function converting means 4, the conversion database memory 5, the function importance level calculating means 17, the operation history database memory 9, shortcut key display order and display method determining means 22, the display order database memory 19, the display method database memory 21, display means 6c, and the key conversion database memory 7.

The function converting means 4, the conversion database memory 5, and the key conversion database memory 7 are the same as those in the first embodiment, and descriptions thereof are omitted here. The importance level calculating means 17 and the display order database memory 19 are the same as those in the eighth embodiment, and descriptions thereof are omitted here. The display method database memory 21 is the same as the one in the ninth embodiment, and a description thereof is omitted here.

The shortcut key display order and display method determining means 22 is means for receiving a function name and an importance level from the function importance level calculating means 17 as inputs and referring to the display order database memory 19 and the display method database memory 21 to output the function name, a place in display order, and a display method.

The display means 6c is means for receiving the function name, the place in display order, and the display method from the shortcut key display order and display method determining means 22 as inputs, and referring to the key conversion database 7 to output a rearranged shortcut key that is a shortcut key associated with the function name in the input place in display order and by a specified display method. In the case where the input place in display order is already taken by another shortcut key, each currently displayed shortcut key is pushed down by one in display order so that the newly output shortcut key is inserted and displayed by a specified display method.

How the information equipment operates is described next.

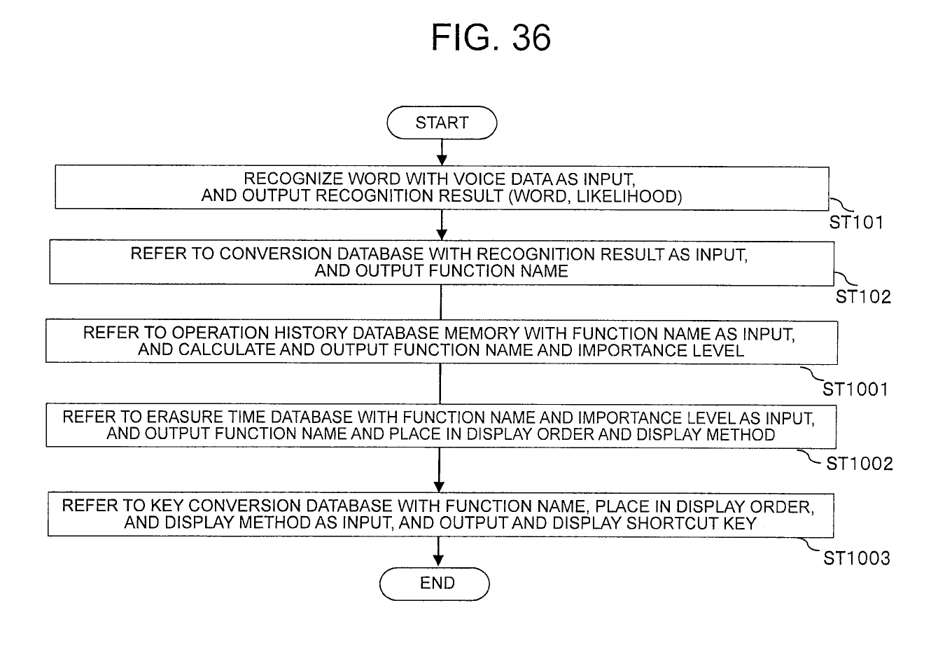

FIG. 36 is a flow chart illustrating the operation of the information equipment of the tenth embodiment.

The specifics of Steps ST101 to ST103 illustrated in FIG. 36 are the same as those of Steps ST101 to ST103 in the first embodiment, and descriptions thereof are omitted here.

As in the eighth embodiment, the importance level calculating means 17 refers to the operation history database memory 9, calculates the importance level based on the chosen count CC by Expression (7) for a function name input thereto which is the output of the function converting means 4, and outputs the importance level (Step ST801).

The function name and importance level output from the importance level calculating means 17 are input to the shortcut key display order and display method determining means 22, which refers to the display order database memory 19 and the display method database memory 21 to determine a place in display order and a display method that are associated with the input importance level, and outputs the function name, the place in display order, and the display method (Step ST1002).

The display order database memory 19 and the display method database memory 21 that are used by the shortcut key display order and display method determining means 22 to determine a place in display order and a display method for each function name are respectively the same as the display order database memory 19 in the eighth embodiment which is illustrated in FIG. 29 and the display method database memory 21 in the ninth embodiment which is illustrated in FIG. 33.

The operation of the shortcut key display order and display method determining means 22 is described in detail below with reference to FIGS. 29 and 33.

In FIGS. 29 and 33, when a function name “search for convenience stores” and an erasure time limit “3 seconds” are input to the shortcut key display order and display method determining means 22, for example, the shortcut key display order and display method determining means 22 refers to the display order database memory 19 to find out that “search for convenience stores” is higher in importance level than “search for family restaurants” (15>10), and therefore updates the display order database memory 19 by giving 1 as the place in display order of “search for convenience stores” and changing the place in display order of “search for family restaurants” to 2, and then outputs “search for convenience stores” and “1” as the place in display order. The shortcut key display order and display method determining means 22 also refers to the display method database memory 21 to find out display method values associated with an importance level “15” for “search for convenience stores”. The shortcut key display order and display method determining means 22 accordingly sets a. wav as a sound used when the function name is displayed (display sound), sets the display size to 48×48 pixels, and sets checker wipe display as a display effect. These are output together as a display method along with the determined place in display order.

The function name, place in display order, and display method output from the shortcut key display order and display method determining means 22 are input to the display means 6c, which outputs and displays a relevant shortcut key in the input place in display order and by the input display method (Step ST1003).

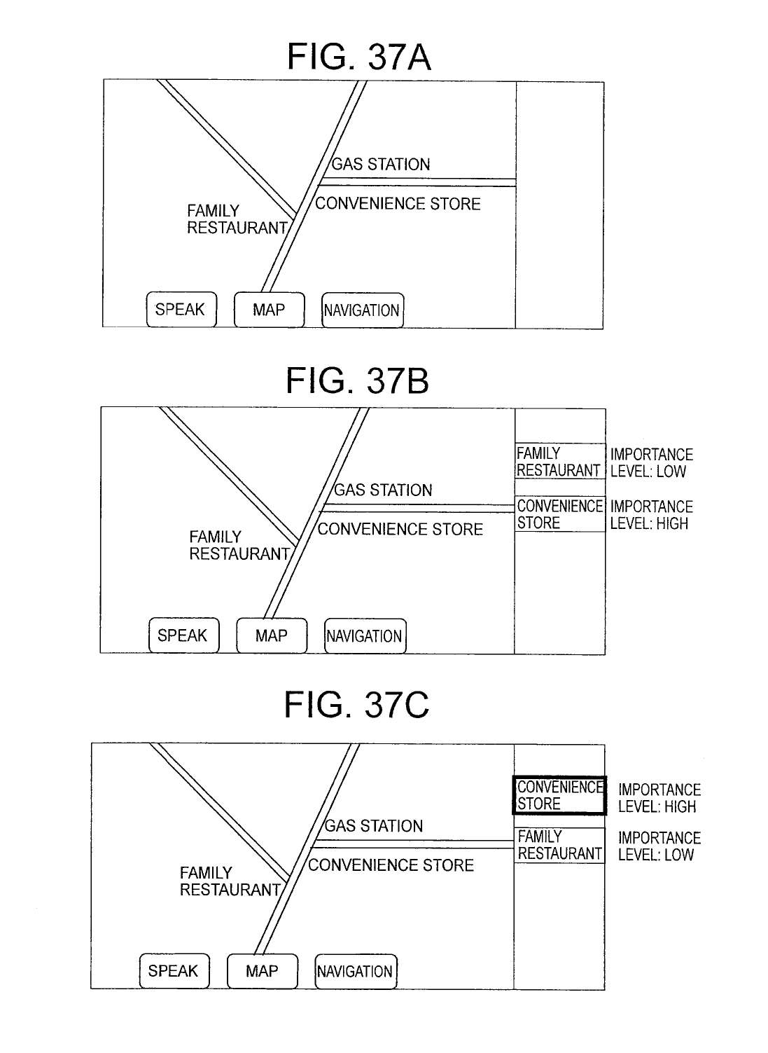

A display example is illustrated in FIG. 37. FIG. 37(A) illustrates the display screen before shortcut key rearrangement. FIG. 37(B) illustrates the display screen after shortcut key rearrangement. FIG. 37(C) illustrates the display screen after a change in shortcut key display order and shortcut key display method.

According to the tenth embodiment where the shortcut key display order and display method determining means 22 and the display means 6c are provided, shortcut keys are presented to the user in/by a display order and display method that are determined by the importance level calculated based on the chosen count. A resultant effect is that the user can easily choose a desired key by checking shortcut keys displayed in the presented order and, for example, by a display method of highlighting the shortcut keys.

The configuration and operation discussed in this embodiment is for determining the order and method in/by which shortcut keys are displayed on the display screen and for displaying in/by the determined order and method. As an alternative configuration, the operation history database memory 9, the function importance level calculating means 17, the shortcut key display order and display method determining means 22, and the display method database memory 21 which are means for determining the order and method in/by which shortcut keys are displayed on the display screen may be added to the second to seventh embodiments. In this configuration, the order and method in/by which shortcut keys are displayed on the display screen is determined and shortcut keys are displayed in/by the determined order and method, the erasure time limit till a shortcut key is erased is calculated for each of the displayed shortcut keys, and the shortcut key is erased when the calculated erasure time limit is reached. This configuration has the effect of this embodiment in addition to the respective effects of the second to seventh embodiments.

The display means 6 in this case has a function of outputting and displaying shortcut keys in display order and by a display method in addition to the function of the display means 6 in the second to seventh embodiments. It should be understood that in a combination of the second embodiment and this embodiment, one operation history database memory 9 fulfills both its role in the second embodiment and its role in this embodiment.

### Eleventh Embodiment

In an eleventh embodiment, a place in display order is calculated for each shortcut key based on the current place in display order of the shortcut key, and shortcut keys whose places in display order are within a display range are displayed whereas shortcut keys whose places in display order are outside the display range are not displayed. Shortcut keys whose places in display order are outside the display range may be deleted from databases.

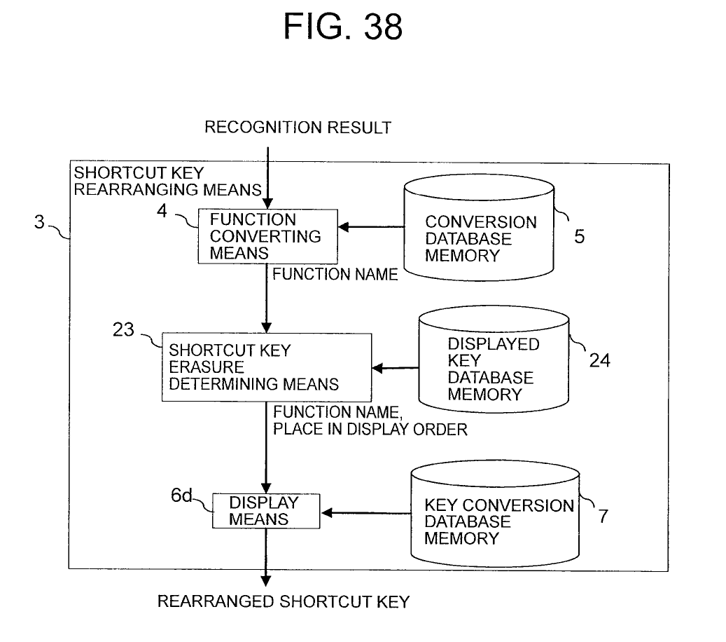

FIG. 38 is a configuration diagram illustrating shortcut key rearranging means 3 according to the eleventh embodiment of the present invention. The overall configuration of the main components of an invention of an information equipment according to the eleventh embodiment of the present invention is as illustrated in FIG. 2, and the eleventh embodiment differs from the first embodiment only in the internal configuration of the shortcut key rearranging means 3.

The shortcut key rearranging means 3 in FIG. 38 includes the function converting means 4, the conversion database memory 5, shortcut key erasure determining means 23, a displayed key database memory 24, display means 6d, and the key conversion database memory 7.

The function converting means 4, the conversion database memory 5, and the key conversion database memory 7 are the same as those in the first embodiment. Descriptions thereof are therefore omitted here.

The shortcut key erasure determining means 23 refers to the displayed key database memory 24 to calculate a place in display order from a pre-update place in display order by the following expression (8) for a function name input thereto which is the output of the function converting means 4, and outputs the calculated place in display order.

[Math. 8]

DO=PDO+1(PDO≧0) (8)

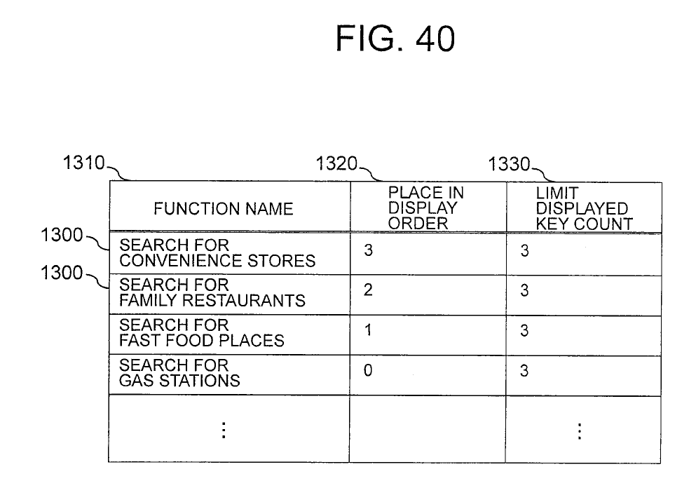

The displayed key database memory 24 is, as illustrated in FIG. 40, a memory for storing a database in which the association between a function name, a place in display order, and a limit displayed key count is written in order to determine a place in display order from a function name. In other words, the displayed key database memory 24 is built to have a table structure that stores a plurality of pieces of conversion information. The limit displayed key count indicates the upper limit of the display range. The lower limit of the display range is set so that any shortcut key whose place in display order is smaller than 1 is displayed, unless otherwise stated.

How the information equipment operates is described next.

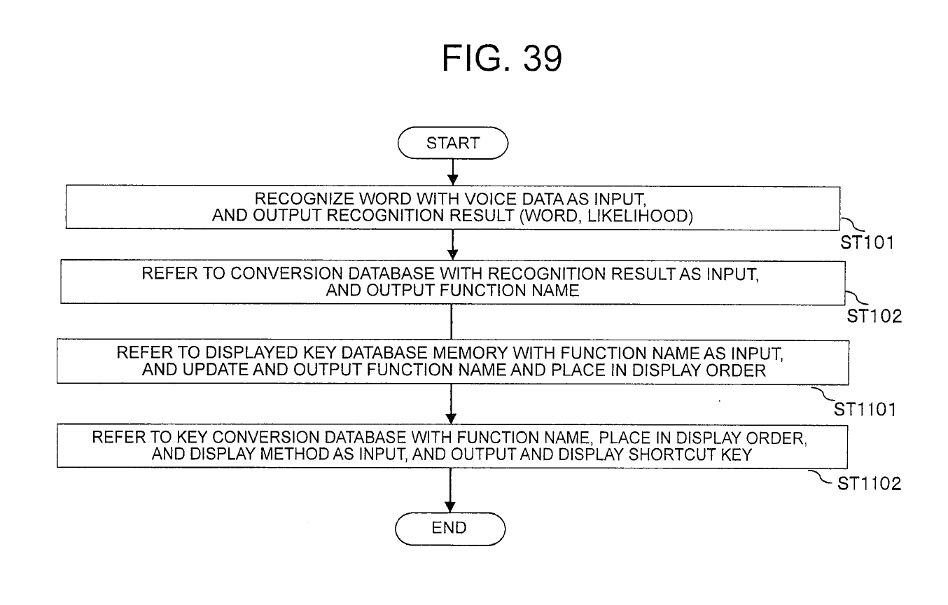

FIG. 39 is a flow chart illustrating the operation of the information equipment of the eleventh embodiment.

The specifics of Steps ST101 and ST102 illustrated in FIG. 39 are the same as those of Steps ST101 and ST102 in the first embodiment, and descriptions thereof are omitted here.

A function name that is the output of the function converting means 4 is input to the shortcut key erasure determining means 23, which refers to the displayed key database memory 24 to calculate and output a place in display order (Step ST1101).

FIG. 40 illustrates a displayed key database which is used to calculate the place in display order in the shortcut key erasure determining means 23 of the eleventh embodiment. The operation of the shortcut key erasure determining means 23 is described in detail below with reference to FIG. 40.

In FIG. 40, a function name “search for gas stations” is input to the shortcut key erasure determining means 23, and 1, 2, and 3 are assigned as pre-update places in display order to function names “search for fast food places”, “search for family restaurants”, and “search for convenience stores”, respectively, for example. The function name “search for gas stations” is first added to the displayed key database memory, with the place in display order set to 1. Next, Expression (8) is used to assign new places in display order, specifically, 2, 3, and 4, to the function names “search for fast food places”, “search for family restaurants”, and “search for convenience stores”, respectively. The shortcut key erasure determining means 23 then outputs a display order for displaying shortcut keys excluding “search for convenience stores” whose place in display order is 4 and larger than the limit displayed key count set to 3, namely, a display order for displaying “search for gas stations”, “search for fast food places”, and “search for family restaurants” in the order stated.

The display means 6a is means for receiving the function name and the place in display order that are output from the shortcut key erasure determining means 23 as inputs and referring to the key conversion database 7 to output a rearranged shortcut key that is a shortcut key associated with the function name in the input place in display order. In the case where the input place in display order is already taken by another shortcut key, each currently displayed shortcut key is pushed down by one in display order so that the newly output shortcut key is inserted and displayed (Step ST1102).

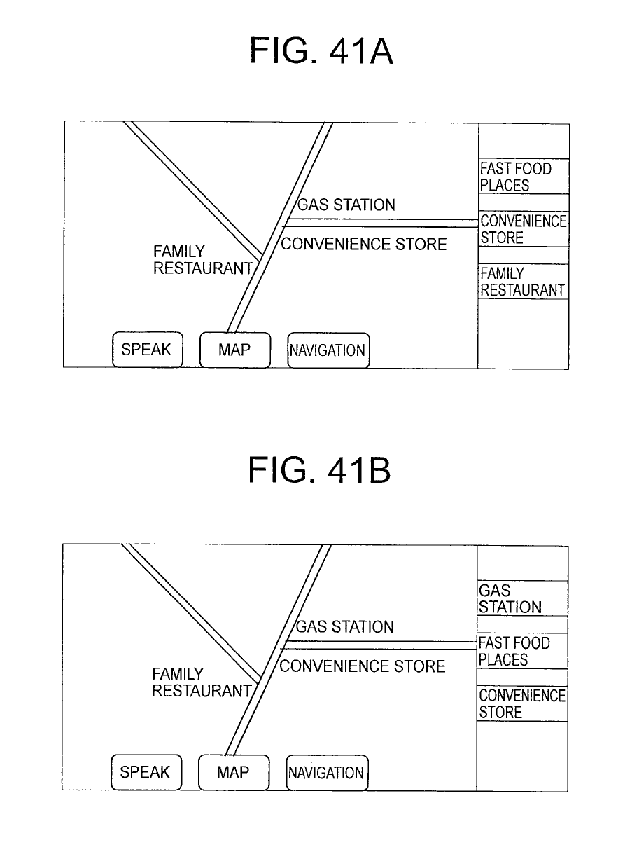

A display example is illustrated in FIG. 41. The illustrated example is of a case where shortcut keys are displayed in the input display order from the top of the right side of the display screen downward. Alternatively, only a shortcut key to be erased and a new shortcut key may switch places on the display screen while shortcut keys that are not erased are left in their displayed places. The information equipment may also be designed so that displayed shortcut keys are not moved only when a three-dimensional sensor or the like senses the approach of the user. The user may visually be notified of a function name to be deleted next, namely, a function name whose place in display order is equal to the limit displayed key count, by displaying its shortcut key in a lighter color, in a smaller display size, or the like.

According to the eleventh embodiment where the shortcut key erasure determining means 23, the displayed key database memory 24, and the display means 6d are provided, a place in display order is calculated for each shortcut key based on the current place in display order of the shortcut key so that shortcut keys whose places in display order are within a display range are displayed whereas shortcut keys whose places in display order are over an upper display limit are not displayed. A resultant effect is that the user can easily choose a desired shortcut key by checking shortcut keys in the displayed order.

### Twelfth Embodiment

In a twelfth embodiment, a place in display order is calculated for each shortcut key based on the current place in display order of the shortcut key, relevant information, and a limit value of the relevant information, and the shortcut key is displayed in the calculated place in display order.

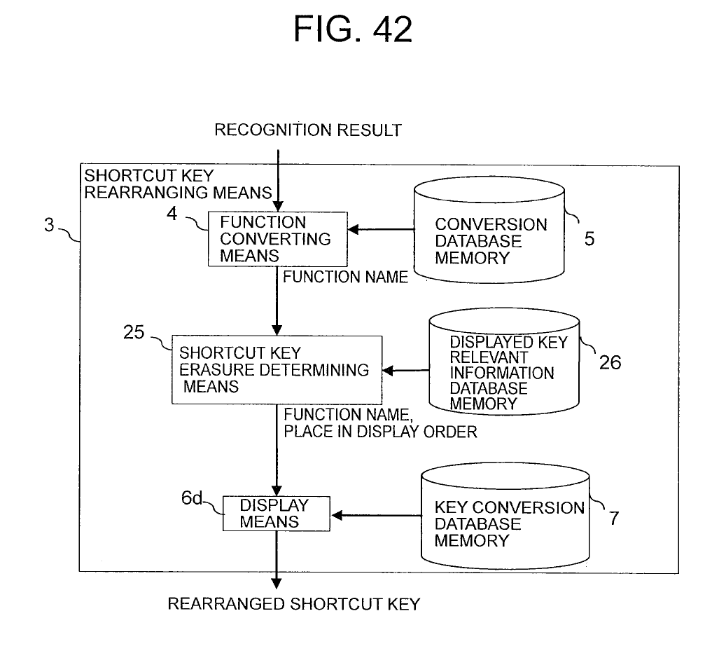

FIG. 42 is a configuration diagram illustrating shortcut key rearranging means 3 according to the twelfth embodiment of the present invention. The overall configuration of the main components of an invention of an information equipment according to the twelfth embodiment of the present invention is as illustrated in FIG. 2, and the twelfth embodiment differs from the first embodiment only in the internal configuration of the shortcut key rearranging means 3.

The shortcut key rearranging means 3 in FIG. 42 includes the function converting means 4, the conversion database memory 5, shortcut key erasure determining means 25, a displayed key relevant information database memory 26, the display means 6d, and the key conversion database memory 7.

The function converting means 4, the conversion database memory 5, and the key conversion database memory 7 are the same as those in the first embodiment, and descriptions thereof are therefore omitted here. The display means 6d is the same as the one in the eleventh embodiment, and a description thereof is therefore omitted here.

The shortcut key erasure determining means 25 is means for referring to the displayed key relevant information database memory 26, receiving a function name which is the output of the function converting means 4 as an input, and outputting a function name and a place in display order.

The displayed key relevant information database memory 26 is a memory for storing a database in which the association between a function name, a place in display order, relevant information, and a limit value of the relevant information is written. In other words, the displayed key relevant information database memory 26 is built to have a table structure that stores a plurality of pieces of conversion information.

How the information equipment operates is described next.

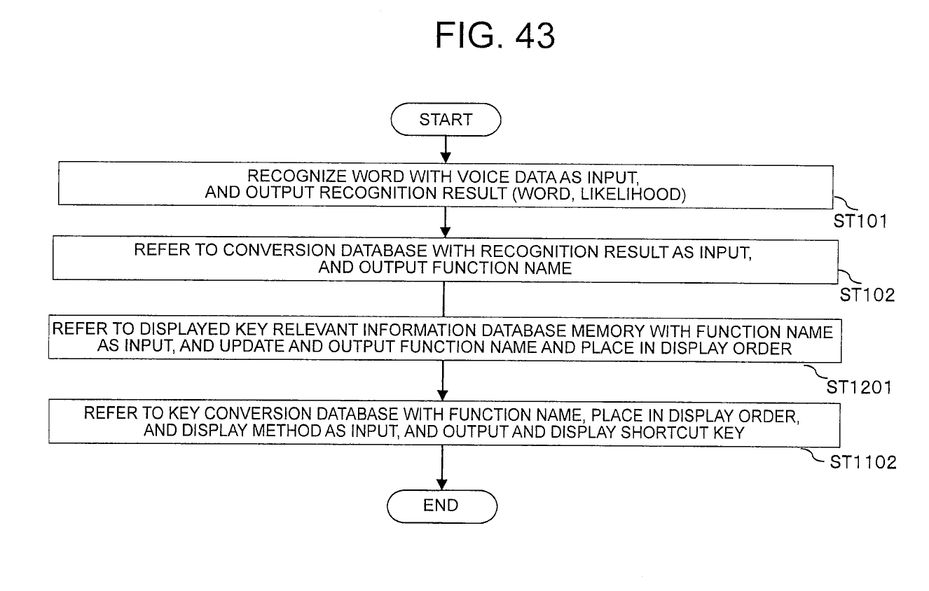

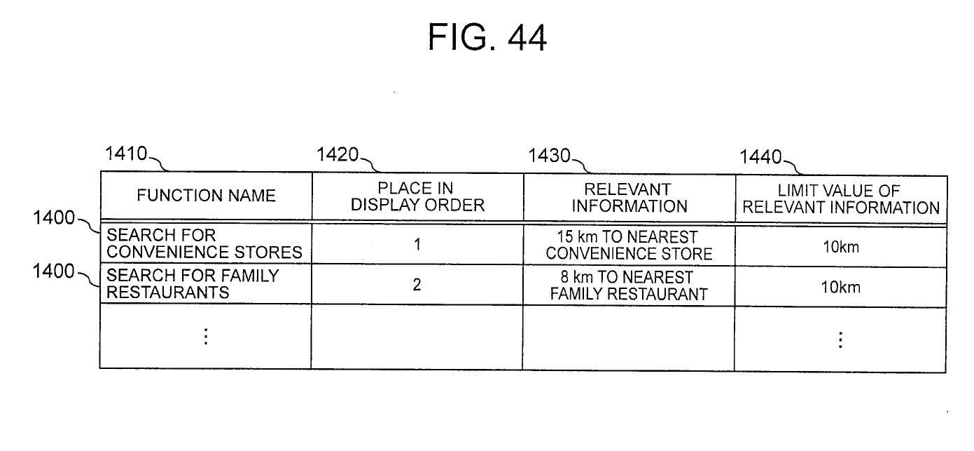

FIG. 43 is a flow chart illustrating the operation of the information equipment of the twelfth embodiment.

The specifics of Steps ST101 and ST102 illustrated in FIG. 43 are the same as those of Steps ST101 and ST102 in the first embodiment, and the specifics of ST1102 illustrated in FIG. 43 are the same as those of Step ST1102 in the eleventh embodiment. Descriptions thereof are therefore omitted here.

A function name that is the output of the function converting means 4 is input to the shortcut key erasure determining means 25, which refers to the displayed key relevant information database memory 26 to calculate and output a place in display order (Step ST1201).

FIG. 44 illustrates a displayed key relevant information database which is used to determine a function name and a place in order to be output in the shortcut key erasure determining means 25 of the twelfth embodiment. The operation of the shortcut key erasure determining means 25 is described in detail below with reference to FIG. 44.

In FIG. 44, when a function name “search for convenience stores” is input to the shortcut key erasure determining means 25, the shortcut key erasure determining means 25 refers to the displayed key relevant information database memory 26 to find out that relevant information that is associated with “search for convenience stores” is “15 km to the nearest convenience store” and that a limit value of the relevant information is “10 km”. The shortcut key erasure determining means 25 in this case outputs as a function name, along with a place in display order, only “search for family restaurants” whose relevant information stored in the displayed key relevant information database memory 26 is within a limit value of the relevant information.

While the relevant information in the example is the distance to an objective facility in the vicinity, information such as whether an objective facility is located on the way, or whether an objective facility is open for business at the time may be used as relevant information.

While the example uses “search for convenience stores” and similar functions to describe the twelfth embodiment, the twelfth embodiment can be carried out for any kinds of function. In addition, if there is a similar alternative to some function names restricted from being output based on relevant information and a limit value of the relevant information, the alternative may be output.

According to the twelfth embodiment where the shortcut key erasure determining means 25, the displayed key relevant information database memory 26, and the display means 6d are provided, a place in display order is calculated for each shortcut key based on the current place in display order of the shortcut key, relevant information, and a limit value of the relevant information so that the shortcut key is displayed in the calculated place in display order, whereas shortcut keys whose relevant information is over the limit values are not displayed. A resultant effect is that the user can easily choose a desired shortcut key by checking shortcut keys in the displayed order.

### Thirteenth Embodiment

In a thirteenth embodiment, a place in display order is calculated for each shortcut key based on the current place in display order of the shortcut key, a comparative function name, and hierarchy information, and the shortcut key is displayed in the calculated place in display order.

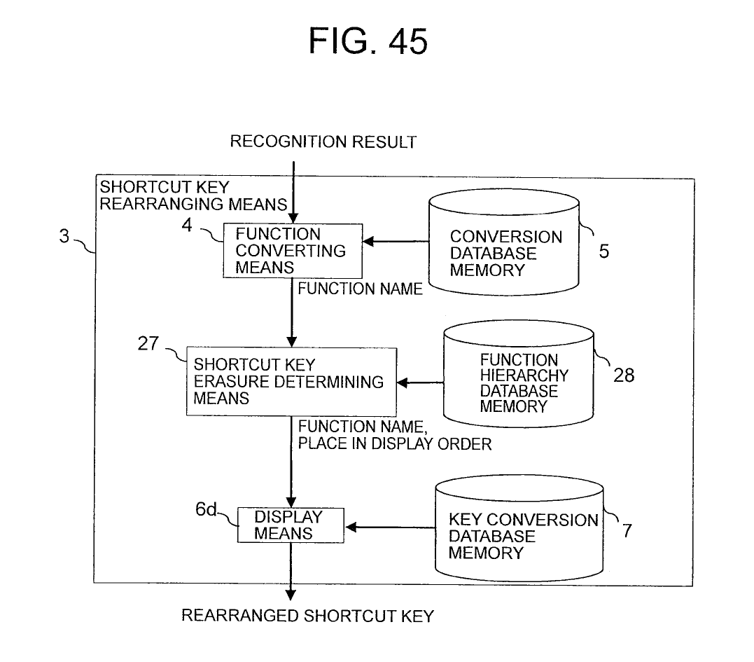

FIG. 45 is a configuration diagram illustrating shortcut key rearranging means 3 according to the thirteenth embodiment of the present invention. The overall configuration of the main components of an invention of an information equipment according to the thirteenth embodiment of the present invention is as illustrated in FIG. 2, and the thirteenth embodiment differs from the first embodiment only in the internal configuration of the shortcut key rearranging means 3.

The shortcut key rearranging means 3 in FIG. 45 includes the function converting means 4, the conversion database memory 5, shortcut key erasure determining means 27, a function hierarchy database memory 28, the display means 6d, and the key conversion database memory 7. The function converting means 4, the conversion database memory 5, the display means 6, and the key conversion database memory 7 are the same as those in the first embodiment and descriptions thereof are therefore omitted here. The display means 6d is the same as the one in the eleventh embodiment, and a description thereof is therefore omitted here.

The shortcut key erasure determining means 27 is means for referring to the function hierarchy database memory 28, receiving a function name which is the output of the function converting means 4 as an input, and outputting a function name and a place in display order.

The function hierarchy database memory 28 is a memory for storing a database in which the association between a function name, a place in display order, a comparative function name, and hierarchy information is written. In other words, the function hierarchy database memory 28 is built to have a table structure that stores a plurality of pieces of conversion information.

How the information equipment operates is described next.

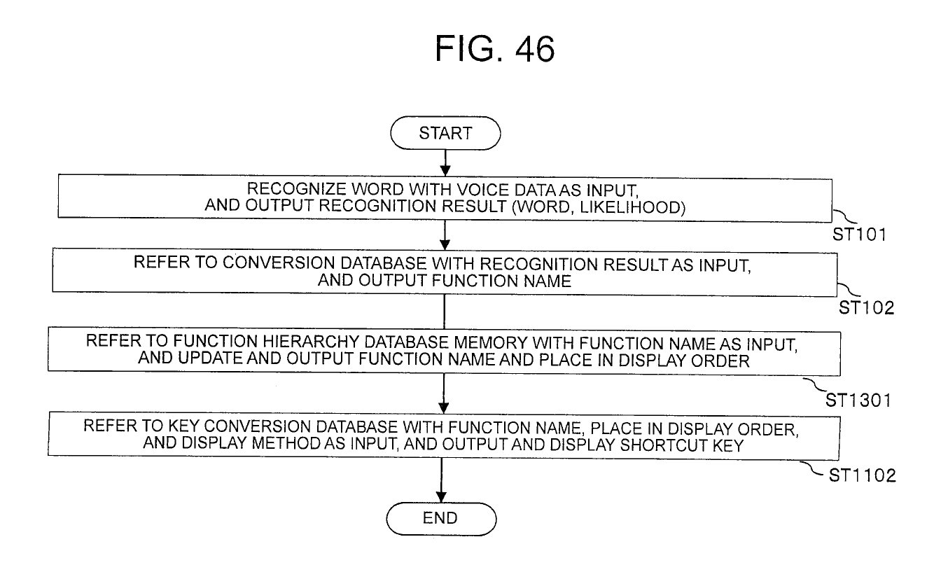

FIG. 46 is a flow chart illustrating the operation of the information equipment of the thirteenth embodiment.

The specifics of Steps ST101 and ST102 illustrated in FIG. 46 are the same as those of Steps ST101 and ST102 in the first embodiment, and the specifics of ST1102 illustrated in FIG. 46 are the same as those of Step ST1102 in the eleventh embodiment. Descriptions thereof are therefore omitted here.

A function name that is the output of the function converting means 4 is input to the shortcut key erasure determining means 27, which refers to the function hierarchy database memory 28 to calculate and output a place in display order (Step ST1301).

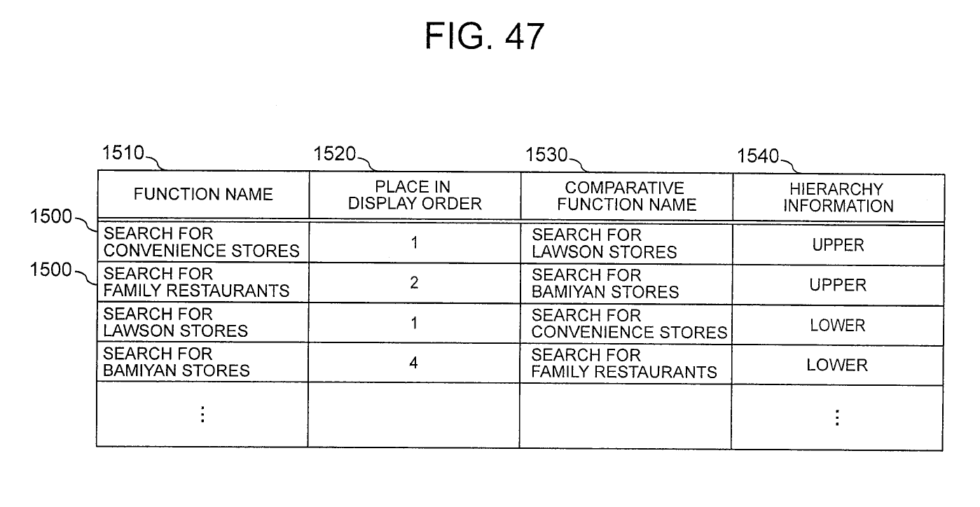

FIG. 47 illustrates a function hierarchy database which is used to determine a function name and a place in order to be output in the shortcut key erasure determining means 27. The operation of the shortcut key erasure determining means 27 is described in detail below with reference to FIG. 47.

FIG. 47 is described first. The function name column and the display order column are the same as those in the twelfth embodiment, and descriptions thereof are omitted here. Written as hierarchy information is whether or not a function name is “upper” or “lower” in hierarchy with respect to a comparative function name. For instance, the hierarchy information is determined so that a function “search for convenience stores” which encompasses a function “search for Lawson stores” is “upper” in hierarchy compared to the function “search for Lawson stores”.

In FIG. 47, when the function name input to the shortcut key erasure determining means 27 is “search for convenience stores”, for example, the shortcut key erasure determining means 27 refers to the function hierarchy database memory 28 to find out that comparative function information that is associated with “search for convenience stores” is “search for Lawson stores”, and that hierarchy information of “search for convenience stores” is “upper”. The shortcut key erasure determining means 27 in this case puts “search for convenience stores” above “search for Lawson stores” in display order. In the example where the place in display order of “search for convenience stores” is 3 and the place in display order of “search for Lawson stores” is 1, “search for convenience stores” which is “upper” in the hierarchy information switches places with “search for Lawson stores” in display order so that the place in display order of “search for convenience stores” is set to 1 whereas the place in display order of “search for Lawson stores” is set to 3. It is sufficient if the display order is updated by putting an “upper” function name above a “lower” function name in display order. For instance, “search for Lawson stores” which is a “lower” function name may be given a place in display order “4” obtained by adding 1 to the place in display order of the “upper” function name “search for convenience stores” which is 3. Alternatively, only “upper” function names may be displayed.

Which one of an “upper” function name and a “lower” function name in the hierarchy information is to be put above the other in display order may be determined by referring to the user's operation history and thus obtaining the user's tendency about which of a shortcut key to the “upper” function and a shortcut key to the “lower” function is chosen when both shortcut keys are displayed.

According to the thirteenth embodiment where the shortcut key erasure determining means 27, the function hierarchy database memory 28, and the display means 6d are provided, a place in display order is calculated for each shortcut key based on the current place in display order of the shortcut key, a comparative function name, and hierarchy information so that the shortcut key is displayed in the calculated place in display order which reflects the hierarchy level of the shortcut key. A resultant effect is that the user can easily choose a desired shortcut key by checking shortcut keys in the displayed order.

### INDUSTRIAL APPLICABILITY

The information equipment according to the present invention is applicable to a multi-modal information equipment that can be operated by touch-screen operation and voice-activated operation. The present invention is particularly effective when applied to car navigation systems that have a touch-screen operation feature and a voice-activated operation feature.

1. An information equipment for displaying shortcut keys for operating the information equipment on a screen and rearranging the displayed shortcut keys on the screen based on a voice recognition result of an input voice, the information equipment comprising:
voice recognition processing means for inputting a voice and referring to a recognition dictionary database memory to output text as a recognition result; and
shortcut key rearranging means for inputting the text as the recognition result of the voice recognition processing means, referring to a conversion database memory, where an association relation between a function of the information equipment and text as the recognition result is written, mapping the recognition result text onto a function of the information equipment, and displaying a shortcut key to the function on the display screen,
wherein the shortcut key rearranging means comprising:
erasure time limit determining means for calculating an erasure time limit, which is a length of time between displaying a shortcut key on the screen and erasing the displayed shortcut key from the screen; and
shortcut key erasure determining means for erasing the shortcut key that is displayed by the display means on the screen when a displayed time of the shortcut key exceeds the erasure time limit.

2. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen; and
an operation history database memory for storing an operation history of the information equipment which comprises a shortcut key chosen count, and wherein
the erasure time limit determining means calculates the erasure time limit based on the shortcut key chosen count stored in the operation history database memory.

3. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen; and
a display history database memory for storing a display history of the shortcut key of the information equipment which comprises a shortcut key displayed count, and wherein
the erasure time limit determining means calculates the erasure time limit based on the shortcut key displayed count stored in the display history database memory.

4. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen; and
a recognition result database memory for storing text as the recognition result of the voice recognition processing means and recognition result likelihood, and wherein
the erasure time limit determining means calculates the erasure time limit based on the recognition result likelihood stored in the recognition result database memory.

5. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen; and
a recognition result database memory for storing a recognized count of text as the recognition result of the voice recognition processing means, and wherein
the erasure time limit determining means calculates the erasure time limit based on the recognized count stored in the recognition result database memory.

6. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen; and
a current state database memory for storing a database in which an association between a function name, an erasure time limit, and a state maintaining time is written, and wherein
the erasure time limit determining means calculates the erasure time limit based on a current time by referring to the current state database memory.

7. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen; and
an operation recognition history database memory for storing a database in which a function-name-to-function-name transition possibility score is written, and wherein
the erasure time limit determining means calculates the erasure time limit based on the function-name-to-function-name transition possibility score stored in the operation recognition history database memory.

8. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen;
an operation history database memory for storing an operation history of the information equipment which comprises a shortcut key chosen count;
function importance level calculating means for calculating a function importance level from an operated count which is stored in the operation history database memory;
a display order database memory for storing a database in which an association between a function name, a function importance level, and a place in display order is written; and
shortcut key display order determining means for referring to the display order database memory to determine, from the function importance level, a place in display order of the shortcut key that is displayed by the display means on the screen.

9. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen;
an operation history database memory for storing an operation history of the information equipment which comprises a shortcut key chosen count;
function importance level calculating means for calculating a function importance level from the chosen count stored in the operation history database memory;
a display method database memory for storing a display method database in which a function importance level and a display method are written; and
shortcut key display method determining means for referring to the display method database memory to determine, from the function importance level, a display method of the shortcut key that is displayed by the display means on the screen.

10. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen;
an operation history database memory for storing an operation history of the information equipment which comprises a shortcut key chosen count;
function importance level calculating means for calculating a function importance level from the chosen count stored in the operation history database memory;
a display method database memory for storing a display method database in which a function importance level and a display method are written;
a display order database memory for storing a database in which an association between a function name, a function importance level, and a place in display order is written; and
shortcut key display order and display method determining means for referring to the display order database memory and the display method database memory to determine, from the function importance level calculated by the function importance level calculating means, a place in shortcut key display order where a shortcut key is displayed and a display method of the shortcut key.

11. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen; and
a displayed key database memory for storing a database in which an association between a function name, a place in display order, and a limit displayed key count is written, and wherein
the shortcut key erasure determining means adds a newly obtained function name to function names that are stored in the displayed key database memory and updates places in display order that are stored in the displayed key database memory, and determines a place in display order of the shortcut key that is displayed by the display means on the screen based on the limit displayed key count.

12. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen; and
a displayed key relevant information database memory for storing a database in which an association between a function name, a place in display order, relevant information, and a limit value of the relevant information is written, and wherein
the shortcut key erasure determining means refers to information relevant to a displayed shortcut key that is stored in the displayed key relevant information database memory to add a function name and update places in display order, and determines a place in display order of the shortcut key that is displayed by the display means on the screen based on the limit value of the relevant information.

13. An information equipment according to claim 1, wherein the shortcut key rearranging means further comprises:
display means for referring to the conversion database memory to map the text input as the recognition result of the voice recognition processing means onto a function of the information equipment, and displaying a shortcut key to the function on the display screen; and
a function hierarchy database memory for storing a database in which an association between a function name, a place in display order, a comparative function name, and hierarchy information is written, and wherein
shortcut key erasure determining means refers to the hierarchy information among function names that are stored in the function hierarchy database memory to add a function name and update places in display order, and determines a place in display order of the shortcut key that is displayed by the display means on the screen.
